(19) United States
(12) Patent Application Publication
(10) Pub. No.: US 2022/0063200 A1
(43) Pub. Date: Mar. 3, 2022

(54) DETECTING THREE-DIMENSIONAL (3D) PART LIFT AND DRAG

(71) Applicant: Hewlett-Packard Development Company, L.P., Spring, TX (US)

(72) Inventors: Sunil Kothari, Palo Alto, CA (US); Tod Heiles, Sumner, WA (US); Luke Bockman, Vancouver, WA (US); Gary J. Dispoto, Palo Alto, CA (US); Md Abdullah Al Hafiz Khan, Palo Alto, CA (US); Ingeborg Tastl, Palo Alto, CA (US)

(73) Assignee: Hewlett-Packard Development Company, L.P., Spring, TX (US)

(21) Appl. No.: 17/413,723

(22) PCT Filed: Jan. 13, 2019
(86) PCT No.: PCT/US2019/014707

§ 371 Date: Jun. 14, 2021

(51) Int. Cl. B29C 64/393; B29C 64/188; B29C 64/218; B29C 64/236; B29C 64/268; G06T 7/00; B33Y 30/00; B33Y 40/20; B33Y 50/02

(52) U.S. Cl. CPC B29C 64/393; B29C 64/188; B29C 64/218; B29C 64/236; B29C 64/268; G06T 7/001; G06T 2207/30164; B33Y 40/20; B33Y 50/02; G06T 2207/10024; G06T 2207/20024; G06T 2207/20224; B33Y 30/00

(57) ABSTRACT

A grazing light system for detecting three-dimensional (3D) Additive Manufacturing Device (3D) part lift and drag may include a grazing light directed along an x, y plane of a build region to illuminate the surface of the build region, an image capture device to capture an image of the build region as illuminated by the grazing light, and an image analysis module to detect protrusions of the part along the x, y plane based on variations of luminance information within data representing the image.

### BACKGROUND

Three-dimensional (3D) printing is dramatically changing the manufacturing landscape. Via 3D printing, articles and components may be manufactured without the resources of a factory or other large-scale production facility. Additive manufacturing systems produce three-dimensional (3D) objects by building up layers of material and combining those layers using adhesives, heat, chemical reactions, and other coupling processes. Some additive manufacturing systems may be referred to as “3D printing devices.” The additive manufacturing systems make it possible to convert a computer aided design (CAD) model or other digital representation of an object into a physical object. Digital data is processed into slices each defining that part of a layer or layers of build material to be formed into the object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is an elevational block diagram of an additive manufacturing device, according to an example of the principles described herein.

FIG. 2 is an elevational block diagram of an additive manufacturing device, according to an example of the principles described herein.

FIG. 3 is a block diagram of an image of a build region including a number of parts being printed, according to an example of the principles described herein.

FIG. 4 is a block diagram of an image of a build region including a number of parts being printed and with a grazing light illuminating a protruding portion of one of the parts, according to an example of the principles described herein.

FIG. 5 is a block diagram of an image of a build region including a number of parts being printed and with a grazing light illuminating a stronger protruding portion of one of the parts compared to FIG. 4, according to an example of the principles described herein.

FIG. 6 is a block diagram of an image of a build region including a number of parts being printed and with one of the parts being subjected to a drag instance, according to an example of the principles described herein.

FIG. 7 is a block diagram of an image of a build region including grazing light components, according to an example of the principles described herein.

FIG. 8 is a flowchart showing a method of detecting three-dimensional (3D) part lift and drag, according to an example of the principles described herein.

FIG. 9 is a flowchart showing a method of detecting three-dimensional (3D) part lift and drag using at least two light sources, according to an example of the principles described herein.

FIG. 10 is a flowchart showing a method of detecting three-dimensional (3D) part lift and drag, according to an example of the principles described herein.

FIG. 11 is a flowchart showing a method of detecting 3D part lift and drag, according to an example of the principles described herein.

FIG. 12 is a flowchart showing a method of detecting 3D part lift and drag, according to an example of the principles described herein.

FIG. 13 is a block diagram of an image of a build region including a number of parts being printed and a plurality of grazing lights, according to an example of the principles described herein.

FIG. 14 is a block diagram of an image of a build region including a number of parts being printed according to FIG. 3 as normalized, according to an example of the principles described herein.

FIG. 15 is a block diagram of an image of a build region including a number of parts being printed and with a grazing light illuminating a protruding portion of one of the parts according to FIG. 4 as normalized, according to an example of the principles described herein.

FIG. 16 is a block diagram of an image of a build region including a number of parts being printed and with a grazing light illuminating a stronger protruding portion of one of the parts compared to FIG. 4 according to FIG. 5 as normalized, according to an example of the principles described herein.

FIG. 17 is a block diagram of an image of a build region including a number of parts being printed and with one of the parts being subjected to a drag instance according to FIG. 6 as normalized, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Examples provided herein include apparatuses, processes, and methods for generating three-dimensional objects. Apparatuses for generating three-dimensional objects may be referred to as additive manufacturing apparatuses. As will be appreciated, example apparatuses described herein may correspond to three-dimensional printing systems, which may also be referred to as three-dimensional printers. In an example additive manufacturing process, a layer of build material may be distributed in a build area, a fusing agent may be selectively distributed on the layer of build material, and energy may be temporarily applied to the layer of build material. As used herein, a build layer may refer to a layer of build material distributed in a build area upon which agent may be distributed and/or energy may be applied resulting in the generation of a layer.

Additional layers may be formed and the operations described above may be performed for each layer to thereby generate a three-dimensional object. Sequentially layering and fusing portions of layers of build material on top of previous layers may facilitate generation of the three-dimensional object. The layer-by-layer formation of a three-dimensional object may be referred to as a layer-wise additive manufacturing process.

In examples described herein, a build material may include a powder-based build material, where powder-based build material may comprise wet and/or dry powder-based materials, particulate materials, and/or granular materials. In some examples, the build material may be a weak light absorbing polymer. In some examples, the build material may be a thermoplastic. Furthermore, as described herein, agent may comprise fluids that may facilitate fusing of build material when energy is applied. In some examples, agent may be referred to as coalescing or fusing agent. In some examples, agent may be a light absorbing liquid, an infrared or near infrared absorbing liquid, such as a pigment colorant. In some examples at least two types of agents may be selectively distributed on a build material. In some examples at least one agent may inhibit fusing of build material when energy is applied.

Example apparatuses may comprise an agent distributor. In some examples, an agent distributor may comprise at least one fluid ejection device. A fluid ejection device may comprise at least one printhead (e.g., a thermal ejection based printhead, a piezoelectric ejection based printhead, etc.). An agent distributor may be coupled to a scanning carriage, and the scanning carriage may move along a scanning axis over the build area. In one example, printheads suitable for implementation in commercially available inkjet printing devices may be implemented as an agent distributor. In other examples, an agent distributor may comprise other types of fluid ejection devices that selectively eject small volumes of fluid.

In some examples, an agent distributor may comprise at least one fluid ejection device that comprises a plurality of fluid ejection dies arranged generally end-to-end along a width of the agent distributor. In some examples, the at least one fluid ejection device may comprise a plurality of printheads arranged generally end-to-end along a width of the agent distributor. In such examples, a width of the agent distributor may correspond to a dimension of a build area. For example, a width of the agent distributor may correspond to a width of a build area. As will be appreciated, an agent distributor may selectively distribute agent on a build material in the build area concurrent with movement of the scanning carriage over the build area. In some example apparatuses, the agent distributor may comprise nozzles including nozzle orifices through which agent may be selectively ejected. In such examples, the agent distributor may comprise a nozzle surface in which a plurality of nozzle orifices may be formed.

In some examples, apparatuses may comprise a build material distributor to distribute build material in the build area. A build material distributor may comprise, for example, a wiper blade, a roller, and/or a spray mechanism. In some examples, a build material distributor may be coupled to a scanning carriage. In these examples, the build material distributor may form build material in the build area as the scanning carriage moves over the build area along the scanning axis to thereby form a layer of build material in the build area.

Some causes of surface defects in parts printed in an additive manufacturing device may be due to a sensitivity to warming and fusing energies supplied by an energy emitting device. The causes of these defects and their remediation may be very different. The part layer content below the defect, and the defect image signature may be analyzed to differentiate between types of defects and provide remediating actions to correct them. One type of defect includes part curl in the bottom layers of a part. Another type of defect may include lifting of parts and swelling of surrounding powder from overheating. This second type of defect is associated with hot, large-volume parts.

As to the part curl in the bottom layers of a part, the physical mechanism for curl in the initial layers of the part may be from differential shrinkage of the top and bottom of the thin slice or layer at the bottom of the part. If the bottom-most layers are solidified, and the top layers shrink, then the part edges curl up. The vertical temperature gradients in the middle of the part slice during solidification and crystallization are of greater importance than the heat transfer outward to the perimeter of the part in the x,y directions.

Process parameters and bottom side agent geology may be adjusted to minimize curl in the target part and reduce the shrinkage of the top layer when the part is thin enough not to have much stiffness. These adjustments may also minimize tilting of the part or changing the orientation in order to minimize curl sensitive bottom sides of the part. The application of additional energy to re-melt the top side of curled parts, and manage their vertical gradient and differential shrinkage during the initial layers, may allow curled parts to be reduced instead of correcting the curled portions using the ablation laser (127). Therefore, fusing or warming energy output by an energy emitting device may be modified as remediation action to reduce curl of the part.

Further, when the surface temperature of the initial layers of a part in the build region of the additive manufacturing device drops below a crystallization onset temperature of approximately 153° C. long enough for crystallization to initiate in a build material such as nylon PA12, the part will begin to shrink and curl as it crystallizes. The part may initially curl on the perimeter portions of the part due to greater cooling to the surrounding build material such as a powder. As the part curls, the part may lift off of the bed surface and become elevated relative to the surrounding build material. The elevated part may then collide with translating devices within the additive manufacturing device such as a spreader roller, hopper, an energy emitting device, and/or a printing agent dispenser initially and may rock back and forth with each pass or may by dragged across the surface of the build region and the build material deposited thereon. The degree of crystallization and part geometry may determine whether the part rocks or is dragged. If part lifting is allowed to continue, the issue of part lifting may, in some instances, cure itself as more fusing agent is applied and the part gains temperature. However, in some instances, the part lifting issue may worsen to the point where it crashes with the translatable elements within the additive manufacturing device. Thus, part lifting and possible part drag is a symptom of out of balance conditions in the build chamber.

The part lifting and possible dragging may occur due to an incorrect calibration in an imaging device such as a forward-looking infrared (FLIR) camera. If the imaging device is improperly calibrated and is reporting temperatures higher than the actual temperature, the additive manufacturing device will not apply an adequate amount of energy to the build material which may result in an actual build region temperature lower than a target temperature. Cold build material temperatures may cause the perimeter of the parts to cool too quickly and cause crystallization, shrink, and curl.

The part lifting and possible dragging may also occur due to a lack of build material. If an inadequate dose of build material is delivered to the build region, the temperature build material in a control region (i.e., region of interest) may cause the proportional- integral derivative (PID) control of the warming lamp power to respond to the change in the build region. This response may cause the warming lamp power to be lowered which may result in the temperature of the build material dropping below the target temperature in some areas of the build region. A lack of build material ruins the build.

The part lifting and possible dragging may also occur due to too much build material. As dose mass of the build material increases beyond a specification of, for example, approximately 7.0 g+/−0.5, more energy may be extracted from the surfaces of the part into the surrounding build material including the dosed mass as it is being spread. This may cause the part surface temperate to drop and may lead to curling. The incoming build material dose acts as a quenching process. If too much heat is removed in the spreading process, the parts will curl and drag at those layers of the build material.

A dose plate heater may also cause parts to curl and drag if the dose plate heater is not providing a correct and uniform temperature to the incoming build material dose. An incoming build material dose that is correct in mass and temperature produces a successful build. If the dose mass varies across the build plate, it may create hot and cold swaths on the build region. If the dose temperature varies across the dose plate (i.e. colder in the front and back), cold zones may be created that might cause the parts to curl.

Printing agent dispenser air leaks may also be a cause of part lifting and possible dragging of the parts. The printing agent dispenser includes an internal cooling system. If the seals on the bottom of the printing agent dispenser are leaking and blowing on the build area, the increased convection this leaking causes may cause parts to curl and drag. This may be detected as a cold streak on FLIR camera images. Further, the build region may include four resistive heaters on the perimeter of the build region. These heaters assist in reducing the thermal roll off in the perimeter of the build area, particularly along the front and rear of the build region. If the resistive heaters are not functioning correctly, the resistive heaters may increase the thermal roll off and result in parts curling and dragging along the front and rear of the build region.

Further, energy emitting device (i.e., a fusing module) may be contaminated with build material along a quartz glass pane located at the bottom of the energy emitting device. This quartz glass pane may become excessively contaminated with burnt on build material. The burnt build material blocks electromagnetic energy from being transmitted from the lamp filament of the energy emitting device to the build material. The reduced energy transfer to the build material causes lower build material temperatures and increased probability of crystallization, curling, and dragging.

Still further, internal energy emitting device contamination may also be a cause of part lifting and possible dragging of the parts. The clean air management system of an additive manufacturing device may not always provide clean cooling air to the energy emitting device. If there is airborne build material in the cooling air, it may burn on the reflectors and lamps of the energy emitting device and may reduce energy transfer into the build material in localized regions. The cooler regions then become potential regions for part curling and dragging. Further, if e.g. all four lamps of the energy emitting device are not functioning correctly, the reduced energy emissions from the energy emitting device may result in the additive manufacturing system being out of balance and part and build material temperatures not reaching the process targets.

Further, as the layers of build material are deposited in the build area, the fusing agent is selectively distributed on the layers of build material, and energy applied to the layer of build material, the parts may experience fluctuations in temperature, humidity, and other environmental conditions within and without the build area of the 3D printing device. These fluctuations in the environmental conditions may cause defects during the manufacturing of the parts. Further, defects within the part may occur as the 3D printing device operates or operates in a deviating manner from its intended mode of operation or in a defective manner. These defects may include a lifting of portions of the part or, stated in another manner, a protrusion of portions of the parts above surrounding build material.

These protrusions may be below a threshold or insignificant enough to not be of a concern to where this type of defect may not significantly affect the look and feel or functionality of the part. Further, the protrusions may not, at these insignificant levels cause the remainder of the 3D printing operations to be affected. However, in many instances, the protrusions may be above the threshold or may be significant enough to cause damage to the part being built and/or cause damage to a number of devices within the 3D printing device. For example, the protrusions in the part may be so severe that the protrusion may come into contact with moveable elements within the 3D printing device such as, for example, a printing carriage including a printing fluid deposition device that is used to deposit the printing fluid onto a layer of build material, a build material deposition device used to deposit the build material within the build region, a build material spreader used to spread the deposited build material in a level plane on the build region, a heating element used to heat the build material in preparation for or in order to fuse or sinter the build material, a fusing or sintering device used to fuse or sinter the deposited build material, and combinations thereof.

Because these devices translate across and/or above the surface of the build region, it is possible that the protruding portions of the part may come into contact with the translating devices. This may cause damage to the translating devices as the protrusion of the part comes into contact with the translating devices. For example, dragging of the part may cause clogging of nozzles of a printing fluid deposition device. Further, the contact between the protrusion of the part and the translating devices may cause the part to be pulled or dragged across the build region damaging the protruding part, other parts being built during the same batch, and combinations thereof. Lift or the formation of the protrusions in the part is a precursor to the dragging of the part. Thus, for the reasons described above, it may be beneficial for the 3D printing device to be able to autonomously detect when a lifting or protrusion of the part occurs, and take remedial action such as discontinuing the build of that part, restarting the build of that part, removing the protrusion from the part, and combinations thereof.

Examples described herein provide a grazing light system for detecting three-dimensional (3D) part lift and drag. The system may include a grazing light directed along an x,y plane of a build region to illuminate the surface of the build region, an image capture device to capture an image of the build region as illuminated by the grazing light, and an image analysis module to detect protrusions of the part along the x,y plane based on variations of luminance information within data representing the image.

The grazing light is a light emitting diode (LED), a profilometer, a collimated light source, a non-collimated light source, a laser device, a laser diode (LD), or combinations thereof. The image capture device captures images in a visible electromagnetic spectrum, an infrared electromagnetic spectrum, an ultraviolet electromagnetic spectrum, or combinations thereof.

The grazing light system may include an ablation laser to remove the protrusions from along the x,y plane in response to a detection of the protrusion by the image analysis module. Detecting protrusions of the part along the x,y plane based on variations of luminance information within data representing the image includes, with the image capture device, capturing a first image of a layer of the part with the grazing light not activated and at least one ambient light source activated to obtain a grazing light off image, with the image capture device, capturing a second image of the layer of the part with the grazing light activated to obtain a grazing light on image, and removing background portions of the grazing light off image and the grazing light on image by subtracting the grazing light off image from the grazing light on image to produce a grazing component of the second image.

Detecting protrusions of the part along the x,y plane based on variations of luminance information within data representing the image may include, with the image capture device, capturing an image of a layer of the part with the grazing light activated and a second light source activated, the second light source producing a band of wavelengths of light different with respect to the band of wavelengths of light produced by the grazing light, and separating the image into a plurality of constituent color planes to obtain a grazing component of the image.

Detecting protrusions of the part along the x,y plane based on variations of luminance information within data representing the image includes, with the image capture device, capturing a first image of a layer of the part with the grazing light not activated and at least one ambient light source activated to obtain a grazing light off image, with the image capture device, capturing a second image of the layer of the part with the grazing light activated to obtain a grazing light on image, with the image capture device, capturing a third image comprising a calibrating image captured at a beginning of a printing process, with the image analysis module, normalizing the first image and the second image based on luminance information within data representing the third image, and removing background portions of the first image and the second image by subtracting the first image from the second image to produce a grazing component of the second image.

Examples described herein provide a method of detecting three-dimensional (3D) part lift and drag includes, with a grazing light directed along an x,y plane of a 3D part build region of a 3D printing device on which a part is built, illuminating the surface of the build region, with an image capture device, capturing an image of the build region as illuminated by the grazing light, and detecting protrusions of the part along the x,y plane based on variations of luminance information within data representing the image.

The method may include, with an ablation laser, removing protrusions from the along the x,y plane in response to a detection of the protrusions by the image analysis module. Detecting protrusions of the part along the x,y plane based on variations of intensity of electromagnetic radiation within the image comprises comparing a plurality of captured images to detect the protrusions, subtracting the plurality of captured images from one another to detect the protrusions based in a remaining grazing component, comparing the plurality of images captured at a plurality of wavelengths and separating the image into a plurality of constituent color planes to obtain the grazing component of the image, filtering the image to pass wavelengths of light of the grazing light to obtain the grazing component of the image, or combinations thereof.

The method may include determining whether the protrusions of the part will come into contact with a translatable device that moves across the build region, and taking remedial action to prevent the protrusions of the part from coming into contact with the layer deposition device.

The remedial action comprises adjusting a layer thickness of a deposited layer, adjusting an amount of an agent deposited on the build region, adjusting torque output by a material spreader, removing protrusions from the the x,y plane with an ablation laser, and combinations thereof. Detecting the protrusions of the part comprises observing violations of an upper control limit (UCL) and a lower control limit (LCL).

Examples described herein provide a non-transitory computer readable medium including computer usable program code embodied therewith, the computer usable program code to, when executed by a processor activate a grazing light directed along an x,y plane of a 3D part build region of a 3D printing device on which a part is built to illuminate the surface of the build region, instruct an image capture device to capture an image of the build region as illuminated by the grazing light, detect protrusions of the part along the x,y plane based on variations of intensity of electromagnetic radiation within the image, and initiate a remedial action to remove the protrusion of the part.

The computer readable medium may include computer usable program code to, when executed by a processor, detect an instance of a part drag based on variations in process parameters, and tag parts within a build that are affected by part dragging.

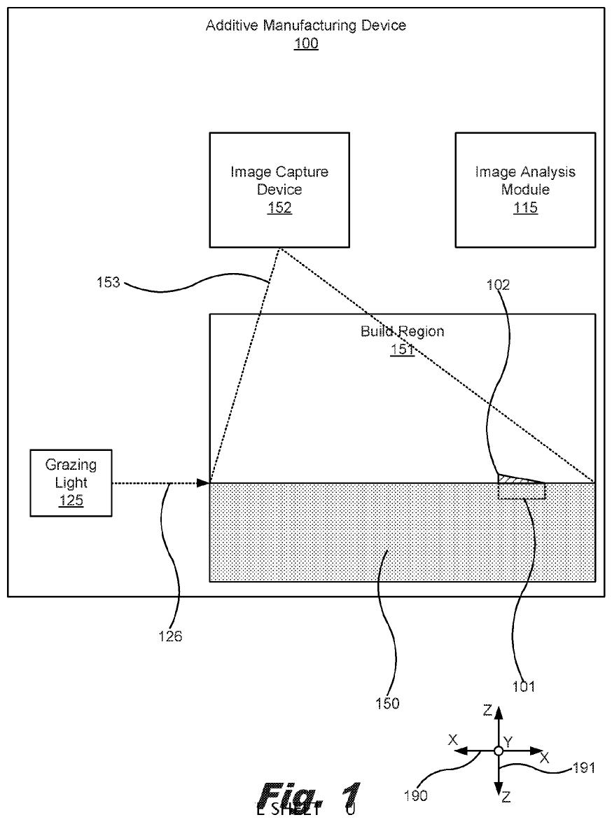

Turning now to the figures, FIG. 1 is an elevational block diagram of an additive manufacturing device (100), according to an example of the principles described herein. The additive manufacturing device (100) may be any device that produces three-dimensional (3D) objects by building up layers of material and combining those layers using adhesives, heat, chemical reactions, and other coupling processes, and may include, for example, a 3D printing device. The additive manufacturing device (100) may form or include a grazing light system for detecting 3D part lift and drag that may occur within the additive manufacturing device (100). Throughout the examples described herein, the lifting of a part (i.e., the formation of protrusions on the part above a surface of the build material is abnormal) is the cause of dragging of the part, and dragging of the part within the build region (151) of the 3D printing device is a failure event that is sought herein to be reduced or eliminated.

The additive manufacturing device (100) may include a build region (151) at which the parts are built. A grazing light (125) may be included that is incident at and directed along an x,y plane (126) of the build material (150) to illuminate the surface of the build material (150) at which the building of the part is implemented. In the examples described herein, the grazing light (125) may be aligned with a top portion of a build material (150) that is consecutively deposited on the top of the layers as the parts are built by the additive manufacturing device (100), and is continually aligned with that top portion of the build material (150) throughout the build. In this orientation and alignment, the electromagnetic wavelengths along the x,y plane (126) output by the grazing light (125) are able to illuminate any protruding portions (102) of a part (101). The part depicted in FIG. 1 has been formed through successive layers of build material (150) being placed on top of one another, and a portion of the part (101) formed exists in lower layers of the build material. The grazing light (125) may cover and entirety of the x,y plane with electromagnetic waves, and may include a light emitting diode (LED), a profilometer, a collimated light source, a non-collimated light source, a laser device, a laser diode (LD), and combinations thereof.

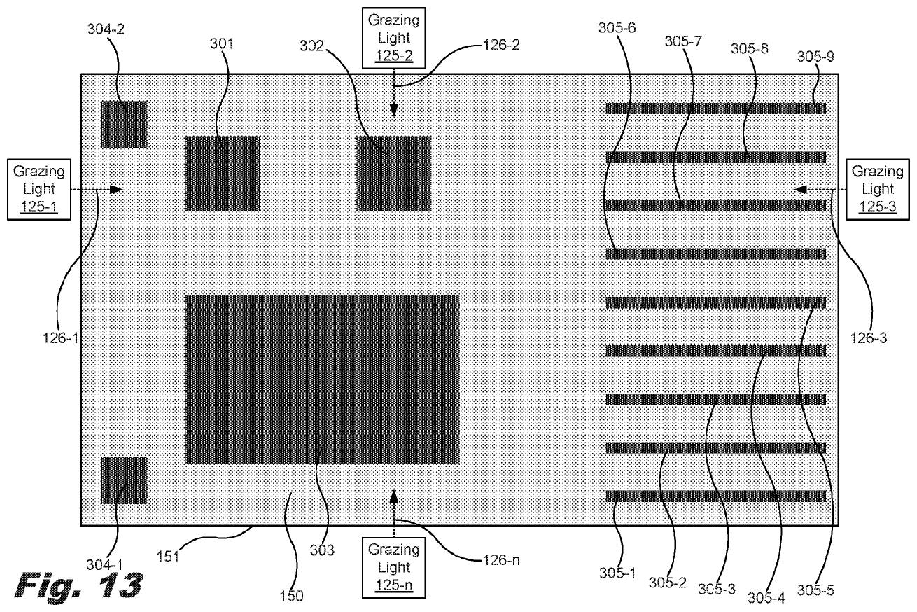

In one example, a plurality of grazing lights (125) may be included within the additive manufacturing devices (100) described herein to improve surface feature identification robustness. Inclusion of multiple grazing lights (125) positioned at a number of orthogonal angles, for example, may provide improved robustness in detecting surface features since the independent images from each source each provide independent analyses of the surface defect. More details regarding this example are described herein in connection with FIG. 13.

The additive manufacturing device (100) may also include at least one image capture device (152) to capture an image of the build region (151) as illuminated by the grazing light (125). The field of view of the image capture device (152) is indicated by lines 153. The image capture device (152) may capture images of the build region (151) in any of a number of wavelengths including ultraviolet (UV) wavelengths, visible wavelengths, infrared (IR) wavelengths, and combinations thereof. In other words, the image capture device (152) may capture images in a visible electromagnetic spectrum, an infrared electromagnetic spectrum, an ultraviolet electromagnetic spectrum, and combinations thereof. Further, the image capture device (152) may be a red-green-blue (RGB) camera, a monochromatic camera, a spectral camera, or combinations thereof.

In one example, a plurality of image capture devices (152) may be included in the additive manufacturing device (100). In one example, the image capture device (152) may be an infrared (IR) camera such as a forward-looking infrared (FLIR) camera to capture thermal images of the build region (151).

The additive manufacturing device (100) may also include an image analysis module (115) to detect protrusions of the part along the x,y plane based on variations of luminance information within data representing the image. The grazing light (125) illuminates the protruding portions (102) of the part (101), and the image capture device (152) captures an image of the build region (151) before and during the building of the part. As depicted in FIG. 1, the left edge of the part (101) is facing the grazing light (125) and presents as a bright edge whereas past the opposite edge of the part on the right, the part (101) casts a shadow a distance such as a number of millimeters (mm) in a direction away from the grazing light (125).

A plurality of images captured by the image capture device (152), and the image analysis module (115) may compare the plurality of images to one another in order to detect the protrusion (102) of the part (101). In one example, a first image of the build region (151) may be captured where the build region (151) is not illuminated with the grazing light (125) and at least one ambient light source activated to obtain a grazing-light-off image. A second image of the build region (151) may be captured where the build region (151) is illuminated by the grazing light (125) to obtain a grazing-light-on image. In the second image, the build region (151) may also be illuminated with at least one ambient light source. In the examples described herein, the ambient light source may be an artificial light included within the additive manufacturing device (100), daylight illuminating the build region (151), and combinations thereof.

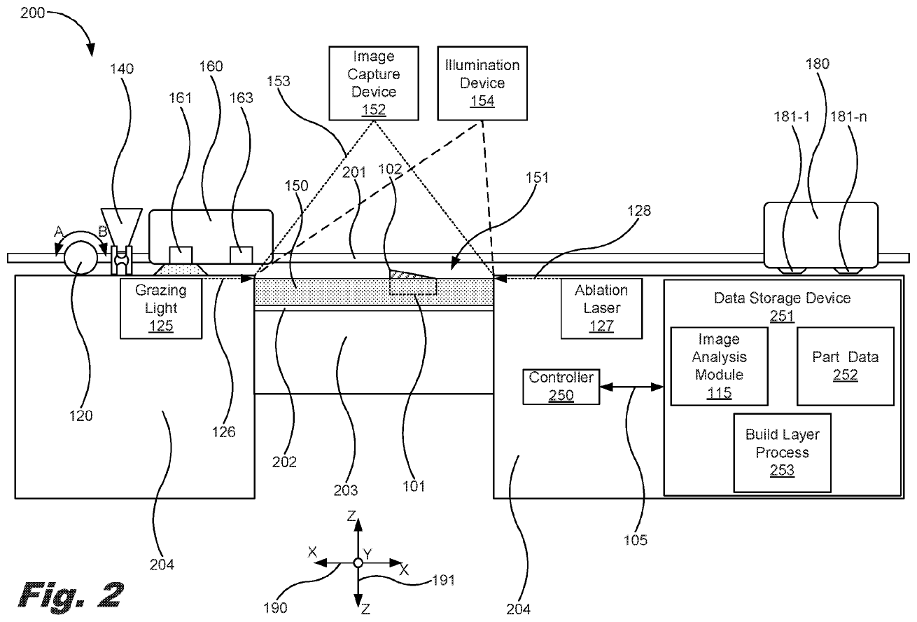

In an example, the grazing light may be positioned at the grazing angle, at an angle at which objects in the build region are diffusedly illuminated, or combinations thereof, and at different times when different images are being captured. In this manner, the shadows will appear crisp and clear. In this example, the second light source may be an artificial light source such as the illumination device (154) or it may be ambient illumination coming through a window in the additive manufacturing device (200), or combinations thereof as depicted in FIG. 2.

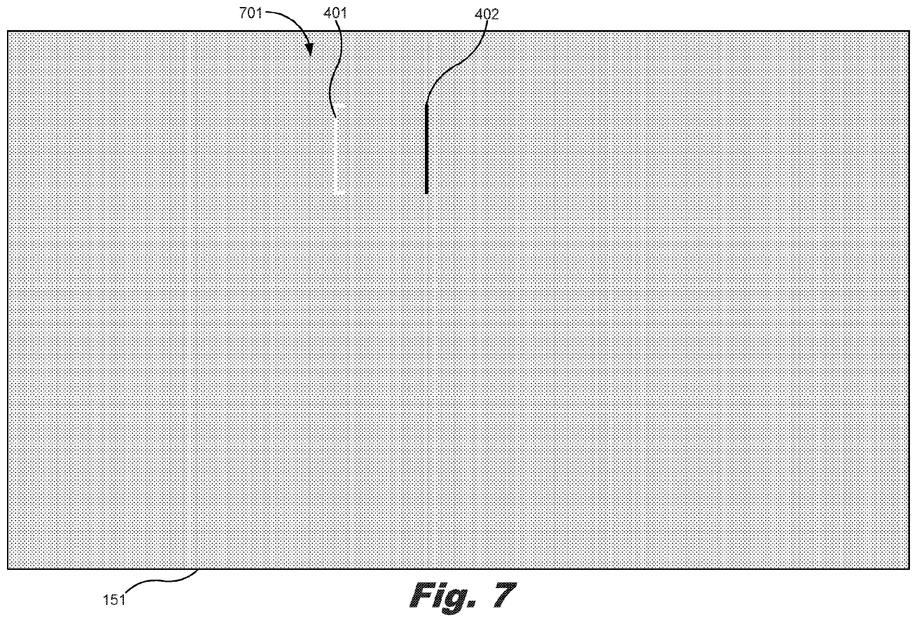

In order to isolate and obtain a grazing light component (FIG. 7, 701) of the images captured by the image capture device (152), the image analysis module (115) may subtract the first image (i.e., the grazing-light-off image) from the second image (i.e., the grazing-light-on image). This method of isolating the grazing light component (FIG. 7, 701) of the images captured by the image capture device (152) may be performed over a plurality of images that are captured at different times during the building of the part and synchronously aligned pixel by pixel. In one example, an image of each layer may be captured after that layer has been laid down and fused.

Once the grazing light component (FIG. 7, 701) of the images is isolated using the image analysis module (115), the image analysis module (115) may identify the variations in luminance within the subtracted images that indicate the presence of lifted portions (102) of the part (101) that protrude past the surface of the build material. The protrusion (102) depicted in FIG. 1 is an exaggeration of proportionality of the protrusion (102), but is shown at this proportionality to properly depict the manner in which the grazing light (125) is able to illuminate the protrusion (102).

FIG. 2 is an elevational block diagram of an additive manufacturing device (200), according to an example of the principles described herein. The additive manufacturing device (200) of FIG. 2 includes those elements described above in connection with the additive manufacturing device (100) of FIG. 1 and includes additional elements. These elements will now be described in more detail. The additive manufacturing device (200) may be implemented in or in connection with an electronic device. Examples of electronic devices include desktop computers, laptop computers, personal digital assistants (PDAs), mobile devices, smartphones, gaming systems, and tablets, among other electronic devices. The additive manufacturing device (200) may be implemented as a standalone device that includes the logic and circuitry to perform the methods described herein.

The additive manufacturing device (200) may be utilized in any data processing scenario including, stand-alone hardware, mobile applications, through a computing network, or combinations thereof. Further, the additive manufacturing device (200) may be used in a computing network, a public cloud network, a private cloud network, a hybrid cloud network, other forms of networks, or combinations thereof. In one example, the methods provided by the additive manufacturing device (200) are provided as a service over a network by, for example, a third party. In this example, the service may include, for example, the following: a Software as a Service (SaaS) hosting a number of applications; a Platform as a Service (PaaS) hosting a computing platform including, for example, operating systems, hardware, and storage, among others; an Infrastructure as a Service (IaaS) hosting equipment such as, for example, servers, storage components, network, and components, among others; application program interface (API) as a service (APIaaS), other forms of network services, or combinations thereof. The present systems may be implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud. In another example, the methods provided by the additive manufacturing device (200) are executed by a local administrator.

To achieve its desired functionality, the additive manufacturing device (200) includes various hardware components. Among these hardware components may be a controller (250) and a data storage device (251). These hardware components may be interconnected through the use of a number of busses and/or network connections such as via a bus (105).

The controller (250) may include the hardware architecture to retrieve executable code from the data storage device (251) and execute the executable code. The executable code may, when executed by the controller (250), cause the controller (250) to implement at least the functionality of operating the various elements of the additive manufacturing device (200). Further, the executable code may, when executed by the controller (250), illuminate the surface of the build region (151) with the grazing light (125), capture an image of the build region (151) as illuminated by the grazing light (125) with an image capture device (152), and detect protrusions (102) of the part (101) along the x,y plane based on variations of luminance information within data representing the image. Still further, the executable code may, when executed by the controller (250), remove the protrusions (102) from the along the x,y plane in response to a detection of the protrusions (102) by the image analysis module using an ablation laser (127), or take some other remedial action described herein. The remedial actions taken by the additive manufacturing devices (100, 200) described herein may include adjusting a layer thickness of a subsequent layer of build material that is deposited on a previous layer, adjusting an amount of an printing agent deposited on the build region (151), adjusting torque output by a material spreader (120), removing protrusions (120) from the along the x,y plane with an ablation laser, and combinations thereof.

As to remedial measures that may correct the protrusion (102) or curling of the part (101) in the bottom layers of a part (101), the physical mechanism for curl in the initial layers of the part may be from differential shrinkage of the top and bottom of the thin slice or layer at the bottom of the part. If the bottom-most layers are solidified, and the top layers shrink, then the part (101) edges curl up. The vertical temperature gradients in the middle of the part slice during solidification and crystallization are of greater importance than the heat transfer outward to the perimeter of the part in the x,y directions.

Thus, to remediate this issue, process parameters and bottom side agent geology may be adjusted to minimize curl in the target part (101) and reduce the shrinkage of the top layer when the part (101) is thin enough not to have much stiffness. These adjustments may also minimize tilting of the part (101) or changing the orientation in order to minimize curl sensitive bottom sides of the part (101). The application of additional energy to re-melt the top side of curled parts manages their vertical gradient and differential shrinkage during the initial layers, may allow curled parts to be reduced instead of correcting the curled portions using the ablation laser (127). Therefore, fusing or warming energy output by the energy emitting device (160) may be modified as remediation action to reduce curl of the part (101). Thus, the use of modified fusing and warming energy including irradiance, exposure time, or combinations thereof may be used by the energy emitting device (160). In one example, the global modification of the energy emitted by the energy emitting device (160) across the full build region (151), as well as locally-modified energy emissions by the energy emitting device (160) at the part (101) with the protrusion (102) may be used to reduce curl of the part (101).

In one example, the protrusion (102) or level of curl of the part (101) may be corrected using modified fusing and warming energies output by the energy emitting device (160) to address curl when the protrusion (102) is detected so that the build may continue at the current layer once the protrusion (102) is reduced to an acceptable level.

Further, the curl detection along with relevant part layer and build process data may be logged using the image analysis module (115) executed by the controller (250) to enable analysis of the correlation between the curl of the part (101) and process modifications so that this information may be used on future layers and future builds in order to increase robustness of the additive manufacturing device (100, 200). The logging of the detection of the protrusion (102) and the correlation between the curl of the part (101) and process modifications may be accompanied with a prompt to a user to inspect and/or perform some type of maintenance of subsystems within the additive manufacturing device (100, 200) that may have caused the protrusion (102) to form so the curling of the part (101) may be corrected before a next build. Further, in one example, detected curl events and process data may be uploaded to other additive manufacturing device (100, 200) or other computing devices. This allows for the correlation data to be analyzed across a plurality of additive manufacturing device (100, 200) and used to define part build contents, orientation, and agent geology that increase curl risk. This correlation data may also be used by the additive manufacturing devices (100, 200) to recommend to a user alternate part orientations (e.g., tilting to minimize bottom surfaces at risk of curl), or agent geology to reduce curl risk, or modifications to process parameters to increase curl robustness.

The executable code may also, when executed by the controller (250), determine whether the protrusions (102) of the part (101) will come into contact with a translatable device that moves across the build region (151), and, in one example, may do so by observing violations of an upper control limit (UCL) and a lower control limit (LCL). These and other functions of the executable code, when executed by the controller (250), are performed according to the methods of the present specification described herein. In the course of executing code, the controller (250) may receive input from and provide output to a number of the remaining hardware units.

The data storage device (251) may store data such as executable program code that is executed by the controller (250) or other processing device. As will be discussed, the data storage device (251) may specifically store computer code representing a number of applications that the controller (250) executes to implement at least the functionality described herein. The data storage device (251) may include various types of memory modules, including volatile and nonvolatile memory. For example, the data storage device (251) of the present example includes Random Access Memory (RAM) , Read Only Memory (ROM), and Hard Disk Drive (HDD) memory. Many other types of memory may also be utilized, and the present specification contemplates the use of many varying type(s) of memory in the data storage device (251) as may suit a particular application of the principles described herein. In certain examples, different types of memory in the data storage device (251) may be used for different data storage needs. For example, in certain examples the controller (250) may boot from Read Only Memory (ROM), maintain nonvolatile storage in the Hard Disk Drive (HDD) memory, and execute program code stored in Random Access Memory (RAM). The data storage device (251) may include a computer readable medium, a computer readable storage medium, or a non-transitory computer readable medium, among others. For example, the data storage device (251) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The additive manufacturing device (200) further includes a number of elements used to form the parts (101) within the build region (151). The additive manufacturing device (200) may include a build platform (202). The build platform (202) may move in the z-direction indicated by arrow (191). More specifically, the build platform (202) may move in the downward z-direction as indicated by arrow (191) to allow for successive layers of build material (150) and printing agent to be deposited at the same level as every other layer of deposited build material (150) and printing agent. In one example, the build plafform (202) may move between 60 and approximately 100 micrometers (pm) in the downward direction between sequential layers of deposited build material (150).

The additive manufacturing device (200) may include a material spreader (120) and at least one hopper (140) movably coupled to a carriage (201) and translatable in the X-direction indicated by arrow (190). The material spreader (120) and hopper (140) may make a plurality of passes over the build plafform (202) dispensing and spreading build material (150) across the build plafform (202), and the carriage (201) may be used to move the material spreader (120) and the hopper (140) in either direction as indicated by arrow (190) as it may be instructed by the controller (250).

The material spreader (120) may be, for example a roller that spans one planar dimension of the build platform (202) to form a level and uniform layer of the build material (150) along the surface of the build platform (202). In one example where the material spreader (120) is a roller, the roller may counter-rotate such that the roller rotates in a direction opposite to its movement relative to the build platform (202). Throughout this description, the terms “material spreader” and “roller” may be used interchangeably.

A hopper (140) may be any device that dispenses an amount of build material for spreading by the material spreader (120). In one example, the hopper (140) may deposit build material (150) in front of and behind the material spreader (120) as the hopper (140) and the material spreader (120) translate above and across the build platform (202). Thus, the hopper (140) may dispense a plurality of doses of the build material in front of the progression of the material spreader (120) as the material spreader (120) is moved over the build platform (202). Although one hopper (140) is depicted in FIG. 2, any number of hoppers (140) may be included in the additive manufacturing device (200). In one example, the hopper (140) may be moved between a front and behind position relative to the movement of the material spreader (120) so that the hopper (140) may dispense the build material (150) in front of and behind the material spreader (120) relative to the materials spreader's direction of travel across the build platform (202). Arrow (190) indicates that the material spreader (120) and the hoppers (140) may move bi-directionally in the X-direction such that material may be dispensed and spread along the build platform (202) in two directions of travel. Throughout the specification and figures, the right direction of arrow (190) is the positive x-direction, and the left direction of arrow (190) is the negative x-direction. Further, the up direction of arrow (191) is the positive z-direction, and the down direction of arrow (191) is the negative z-direction.

In one example, a stage (204) may be included on either side of the build platform (202) to allow for build material (150) to be deposited on the stage (204), and spread from the stage (204) to the build platform. In one example, an amount or dose of build material (150) may be deposited on either side of the build platform (202) and on the stage (204), and the material spreader (120) may spread the build material (150) from the stage (204) from either X-direction as indicated by arrow (190). In one example, the hopper (140) may spread build material (150) over the build platform (202). In one example, excess build material (150) may be staged or deposited on either side of the stage (204) before being spread over the build platform (202) to allow the material spreader (120) to spread this build material (150) in a subsequent pass over the build platform (202) and stage (204).

The additive manufacturing device (200) may also include a controller (250) used to control the functions and movement of the various elements of the additive manufacturing device (200) described herein. For example, the controller (250) may control the movement of the carriage (201) and, in turn, the movement of the build material dispensing device (201) and its elements over the stage (204) and build platform (202). Further, the controller (250) may control the movement of the build platform (202) relative to the stage (204). Still further, the controller (250) may control the quantity of build material (150) and printing agent deposited by the elements moveably coupled to the carriage (201).

The build platform (202) may be supported by build platform base (203). The build platform (202) and/or the build platform base (203) may be moveably coupled to the stage (204) to allow for the build platform (202) and the build platform base (203) to be moved up and down in order to form layers of the 3D object with the build material (150) and the agent.

The material spreader (120) and the hoppers (140) which are part of the additive manufacturing device (200) are moveably coupled to the carriage (201). The carriage (201) may traverse a length of the additive manufacturing device (200) so that the additive manufacturing device (200) may move over the entirety of the build platform (202). The carriage (201) may include a carriage drive shaft, a carriage coupling device and other devices to couple a material spreader (120), the hoppers (140), an energy emitting device (160), a printing agent dispenser (180), or combinations thereof to the carriage (201). In one example, a plurality of carriages (201) may be included on the additive manufacturing device (200) to move the material spreader (120), the hoppers (140), an energy emitting device (160), and a printing agent dispenser (180), independently or collectively.

The additive manufacturing device (200) may also include an energy emitting device (160). The energy emitting device (160) is moveably coupled to the carriage (201) and may move along with the additive manufacturing device (200) in order to warm the build material (150) and/or fuse, sinter, bind, or cure the build material (150). Thus, the energy emitting device (160) may be any device that emits electromagnetic energy at any wavelength to warm and/or fuse or sinter the build material (150), a printing agent; and a combination of build material and printing agent. In one example, the energy emitting device (160) may include at least one warming lamp (161) that emits electromagnetic energy sufficient to warm the build material (150) deposited or spread along the surface of the stage (204) and the build platform (202). Warming of the build material (150) serves to prepare the build material (150) for solidification including, for example binding or thermal fusing. Further, the electromagnetic radiation from the warming lamp (161) serves to maintain the build material (150) and the object being formed from the build material (150) at a relatively more uniform and non-fluctuating temperature. In the case of thermal binding systems, if the build material (150) and the object being formed are allowed to cool or otherwise fluctuate in temperature, the part (101) or layers thereof may become warped, and this warping may form the protrusions (102) of the part (101).

The energy emitting device (160) may also include at least one fusing lamp (163). The fusing lamp (163) emits electromagnetic energy sufficient to fuse the build material (150) together through the use of the printing agent. Fusing of the build material a layer at a time serves to form the part (101) (i.e., a 3D object). With the warming lamp (161) warming the build material (150), the fusing lamp (163) may fuse the build material (150) where the printing agent has been printed and in all coordinate directions within the part (101) including between layers of fused build material (150) by allowing the warming lamp (161) to keep previous, solidified layers at a fusible temperature and fusing the build material (150) spread across the previous, fused layer to fuse to the layer of build material (150) to the previous layer. In one example, the energy emitting device (160) may include one warming lamp (161) and three fusing lamps (163). In one example, the warming lamp (161) may remain on or activated during the build processes described herein. The build material (150), without fusing or printing agents deposited thereon, may absorb a small amount of energy from the fusing lamps. In another example, the voltage to the fusing lamps (163) may be lowered when the build platform (202) is being warmed or a fusing or binding process is not being performed in order to reduce power consumption. In on example, the warming lamp (161) may be located at a fixed position above the build area (150).

The additive manufacturing device (200) may also include a printing agent dispenser (180) to dispense a printing agent onto the build material (150) spread along the surface of the build platform (202). The printing agent may include, for example, active ingredients, detailing agents (DA), fusing agents, sintering agents, other printing agents, and combinations thereof, that may be used to bring about the fusing or sintering of the build material (150) and compensate for a rise in temperature among the layers of the part being printed. The printing agent dispenser (180) may be moveably coupled to the carriage (201), and may move with the energy emitting device (160) over the surface of the build platform (202). The printing agent dispenser (180) may include at least one fluidic die (181-1, 181-n, collectively referred to herein as 181) used to dispense a volume of the printing agent onto the build material (150). In the example of FIG. 2, the printing agent dispenser (180) includes two fluidic die (181-1, 181-n), but may include any number of fluidic die (181) as denoted by the “n” in 181-n. In one example, the fluidic die (181) may be digitally addressable such that the printing agent may be dispensed on the build material (150) that is spread across the surface of the build platform (202) in a pattern as defined by part data (252) provided to the additive manufacturing device (200). Wherever the fluidic die (181) of the printing agent dispenser (180) dispenses the printing agent onto the build material (150) spread across the build platform (202), the fusing lamp (163) will fuse the build material (150) and form a layer of the 3D object.

The additive manufacturing device (200) may also include logic and circuitry to cause the material spreader (120), the hopper (140), the energy emitting device (160), the printing agent dispenser (180), the build platform (202), and the build platform base (203) to move and actuate in a manner that produces the part (101) based on part data (252) stored in a data storage device (251) of the additive manufacturing device (200). For example, the additive manufacturing device (200) may include the controller (250). The controller (250) may include the hardware architecture to retrieve executable code from the data storage device (251) and execute the executable code as described herein. The executable code may, when executed by the controller (250), cause the controller (250) to implement at least the functionality of sending signals to the material spreader (120), the hopper (140), the energy emitting device (160), the printing agent dispenser (180), the build platform (202), and the build platform base (203) to instruct these devices to perform their individual functions according to the methods of the present specification described herein. In the course of executing code, the controller (250) may receive input from and provide output to a number of the remaining hardware units.

The additive manufacturing device (200) may also include at least one additional illumination device (154). Although one illumination device (154) is depicted in FIG. 2, any number of illumination devices (154) may be included within the additive manufacturing device (200). Each of the illumination devices (154) may be independently activated to allow for different intensities of light to be projected onto the build region (151). Further, each of the illumination devices (154) may provide different wavelengths of light including different colors within the visual spectrum of electromagnetic radiation as well as wavelengths with higher or lower frequencies such as IR and UV light. In this manner, a variety of different lighting may be provided to the build region (151) in order for the image capture device (152) to capture images of the build region (151) in different lighting. Providing a variety of different lighting via the illumination devices (154) may allow for the image analysis module (115) described herein to analyze and detect protrusions (102) of the parts (101) and their dimensions with more accuracy and precision. Further, the grazing light (125) may be positioned relative to the build region (151) may be positioned so that the illumination devices (154) generate shadows in instances where there exist protrusions (102) in the part (101). To optimize these lighting objectives, the grazing light (125) may be positioned in several locations in order to detect uprising of edges of the parts in the x- and y-directions and in a combination of both directions. Further, the grazing light (154) may be placed at grazing angles in order to optimize the length of the shadows. In the examples described herein, where narrow band illumination devices (154) are used, the narrow band illumination devices (154) may be bright enough that a good image may be captured by the image capture device (152).

The part data (252) stored in the storage device (251) may be obtained from an external source such as, for example, a computer-aided design (CAD) system that provides a CAD model of the 3D object and may be in any format such as, for example, a 3D printing file format, a 3D manufacturing format (3MF) file format, stereolithography (STL) file format, additive manufacturing format (AMF) file format, Wavefront Object (OBJ) file format, virtual reality modeling language (VRML) file format, X3D XML-based file format, Filmbox (FBX) file format, initial graphics exchange specification (IGES) file format, ISO 10303 (STEP) file format, point cloud data from a 3D scan of an object, other types of 3D printing file formats, and combinations thereof. The build layer process (253) may be any data stored in the data storage device (251) that defines the process the controller (250) follows in instructing the material spreader (120), the hopper (140), the energy emitting device (160), the printing agent dispenser (180), the build platform (202), and the build platform base (203) to produce the part (101) over a number of build material (150) and printing agent layers.

The material spreader (120) may include a material spreading roller that counter-rotates such that it rotates in a direction opposite to its movement relative to the build platform. Thus, if the additive manufacturing device (200) including the material spreader (120) and the hopper (140) move in the positive x-direction as indicated by arrow (190), then the roller will rotate in the direction of arrow A. In contrast, if the additive manufacturing device (200) including the material spreader (120) and the hopper (140) move in the negative x-direction as indicated by arrow (190), then the roller will rotate in the direction of arrow B.

The additive manufacturing device (200) also includes the grazing light (125) and the image capture device (152) as described above in connection with the example of FIG. 1. In addition, the additive manufacturing device (200) may include an ablation laser (127). The ablation laser (127) may be used to remove the protrusion (102) of the part (101). The ablation laser (127) may emit electromagnetic radiation (127) sufficient to ablate material. Thus, the ablation laser (127) may be any laser device that can remove or sublimate material from a solid surface by irradiating it with a culminated beam of electromagnetic radiation. At low laser flux, the fused or sintered build material may be heated by the absorbed laser energy and evaporates or sublimates. At high laser flux, the fused or sintered build material may be converted to a plasma. Thus, laser ablation refers to removing material with a pulsed laser, or ablating material with a continuous wave laser beam in situations where the laser intensity is high enough. Excimer lasers of deep ultra-violet light may be used in photoablation, and may output wavelengths of approximately 200 nm.

In one example, the ablation laser (127) may be coupled to an arm that articulates to place the ablation laser (127) in a position where the ablation laser (127) may ablate the protrusion (102) of the part (101). In one example, the image analysis module (115) of the additive manufacturing device (200) may estimate the height of the protrusion (102). Once the height has been determined, the ablation laser (127) may be activated to ablate the protrusion (102) using an energy level that is based on the height of the protrusion (102). As the ablation laser (127) is activated, the ablation laser (127) may move independently of the carriage (201), the movement of the arm may be minimized. Further, the use of the ablation laser (127) to remediate the protrusion (102) may include activating the ablation laser (127) to ablate the protrusion (102) of the (101) in a column-wise manner, a row-wise manner, or combinations thereof. The systems and methods described herein may execute the image analysis module (115) to verify the ablation of the protrusion (102) immediately after the activation of the ablation laser (127), during activation of the ablation laser (127), after the activation of the ablation laser (127), or combinations thereof. The total time the ablation laser (127) may take to traverse the locations of the parts (101) within the build region (151) may be minimized.

The additive manufacturing device (200) may further include a number of modules used in the implementation of the methods and systems described herein. The various modules within the additive manufacturing device (200) include executable program code that may be executed separately. In this example, the various modules may be stored as separate computer program products. In another example, the various modules within the additive manufacturing device (200) may be combined within a number of computer program products; each computer program product including a number of the modules.

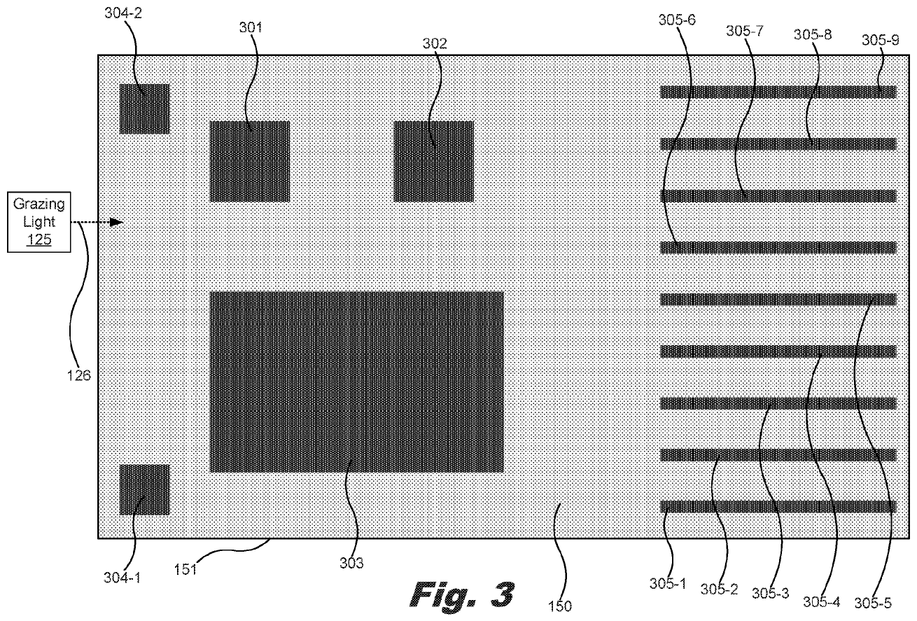

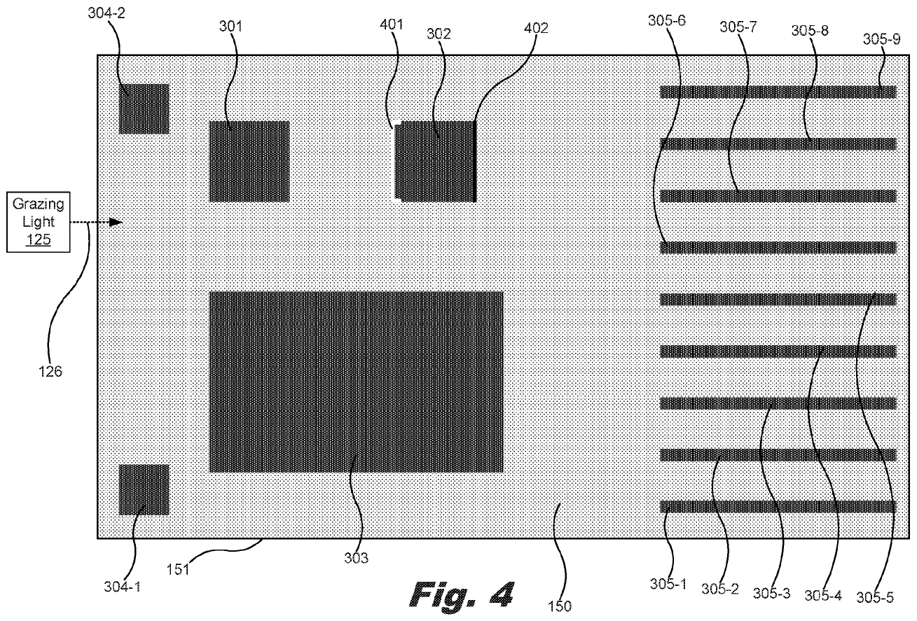

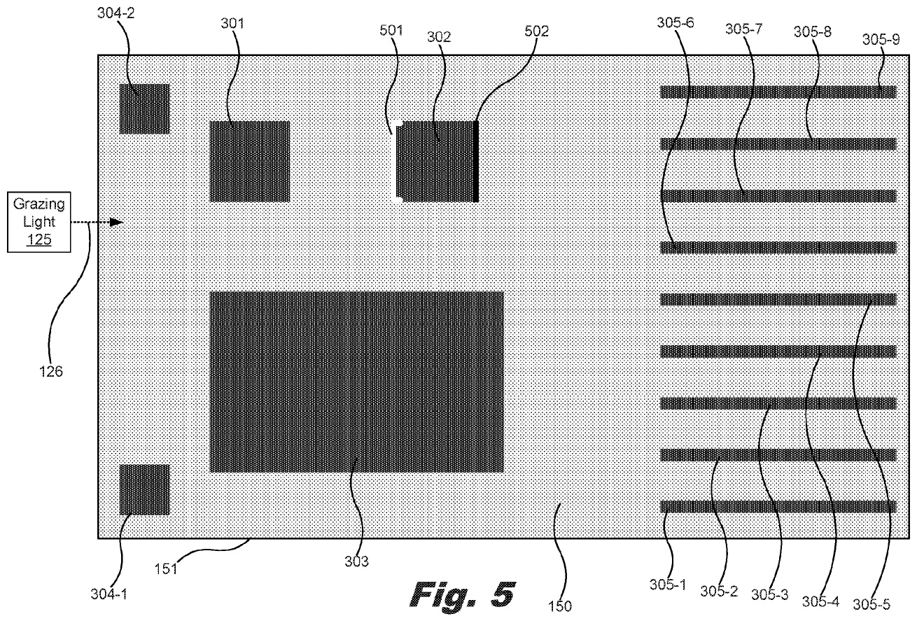

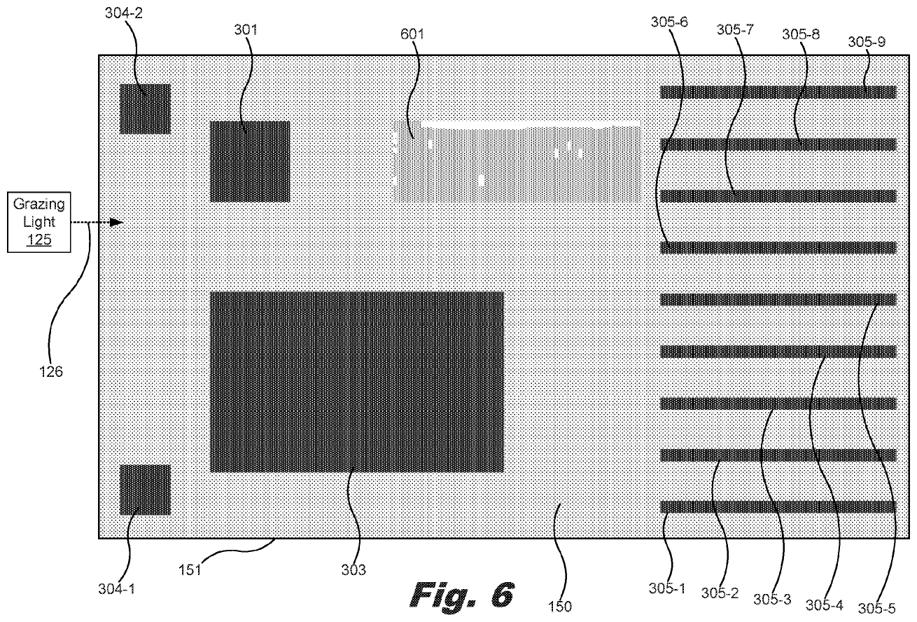

The additive manufacturing device (200) may include the image analysis module (115) described herein. The function of the image analysis module (115) and the remainder of the elements of the additive manufacturing device (200) will now be described in connection with FIGS. 3 to 9 and 13. FIG. 3 is a block diagram of an image of the build region (151) including a number of parts (301, 302, 303, 304-1, 304-2, 305-1, 305-2, 305-3, 305-4, 305-5, 305-6, 305-7, 305-8, 305-9, collectively referred to herein as 101) being printed, according to an example of the principles described herein. FIG. 13 is a block diagram of an image of a build region (151) including a number of parts (301, 302, 303, 304-1, 304-2, 305-1, 305-2, 305-3, 305-4, 305-5, 305-6, 305-7, 305-8, 305-9, collectively referred to herein as 101) being printed and a plurality of grazing lights (125-1, 125-2, 125-3, 125-n), according to an example of the principles described herein. Further, FIG. 4 is a block diagram of an image of the build region (151) including a number of parts (301, 302, 303, 304-1, 304-2, 305-1, 305-2, 305-3, 305-4, 305-5, 305-6, 305-7, 305-8, 305-9) being printed and with the grazing light (125) illuminating a protruding portion of one of the parts (301, 302, 303, 304-1, 304-2, 305-1, 305-2, 305-3, 305-4, 305-5, 305-6, 305-7, 305-8, 305-9), according to an example of the principles described herein. FIG. 5 is a block diagram of an image of the build region (151) including a number of parts (301, 302, 303, 304-1, 304-2, 305-1, 305-2, 305-3, 305-4, 305-5, 305-6, 305-7, 305-8, 305-9) being printed and with the grazing light (125) illuminating a stronger protruding portion of one of the parts (302) compared to FIG. 4, according to an example of the principles described herein. FIG. 6 is a block diagram of an image of the build region (151) including a number of parts (301, 302, 303, 304-1, 304-2, 305-1, 305-2, 305-3, 305-4, 305-5, 305-6, 305-7, 305-8, 305-9) being printed and with one of the parts (302) being subjected to a drag instance, according to an example of the principles described herein. FIGS. 3 through 6 may be sequential layers of build materials applied to one another in the z-direction (FIG. 2, 191) such as, for example, layers 1258, 1259, 1,60, and 1261 of the build, respectively. The grazing light (125) is activated in each of FIGS. 3 through 6. Further, each of the parts (301, 302, 303, 304-1, 304-2, 305-1, 305-2, 305-3, 305-4, 305-5, 305-6, 305-7, 305-8, 305-9) have begun to be printed.

At layer 1258 depicted in FIG. 3, no protrusions are detected, and this is determined as the grazing light (125) is activated, the image capture device (152) captures at least one image of the build region (151), and the variations of luminance information within data representing the image indicate that no protrusion (102) exists. The image analysis module (115) is executed by the controller (250) in order to make this determination. When the images are captured by the image capture device (152), a plurality of images may be captured. For example, a control image may be captured which includes an image of the build region (151) where no parts or a number of calibration parts such as parts (304-1, 304-2) are depicted. This control image may serve as a baseline as to how the luminance of the build region (151) may look without an instance of a protrusion (102) and may be compared to other images captured by the image capture device (152) to detect in those subsequent images the presence of a protrusion (102) of a part. The luminance information within the data representing the subsequent images may be compared to the luminance information in the control image, and any variation may result in the image analysis module (115) detecting a protrusion (102) in the part.

In FIG. 4, a protrusion (102) is detected in part (302) being built as an illuminated portion (401) is created as the light from the grazing light (125) hits it, and a shadow portion (402) is created as the light from the grazing light (125) is blocked by the protrusion (102). FIG. 5, being a layer after the layer depicted in FIG. 4, may include a more pronounced protrusion (501) on the part (302) which may create an illuminated portion (501) and which may cast an equivalently larger shadow portion (502). In one example, the height of the protrusion (102) above the x,y plane of the last-deposited layer of build material may be measured by the level of illuminance of the illuminated portion (401, 501), the width of the shadow portion (402, 502) past the part (302), and combinations thereof. The height of the protrusion (102) may be indicative of the severity of the lift of the part (302) (i.e., the protrusion (102)) and may be used to determine how much energy may be used by the ablation laser (127) to remove the protrusion (102). Further, the height of the protrusion (102) may be used to determine whether the protrusion (102) will come into contact with any of the translatable elements of the additive manufacturing device (100, 200) such as the material spreader (120), the hopper (140), the energy emitting device (160), the printing agent dispenser (180), or combinations thereof. In one example, the height of the protrusion (102) may be determined in order to determine the severity of the lift of the part (302) and, in some instances, determine whether the part (302) may come into contact with any of the devices that translate across the build region (151). FIG. 6 is an image of the build region including part (302) of FIGS. 3, 4, and 5 being subjected to a drag instance (601). In the example of FIG. 6, the drag instance (601) has occurred because the protrusion (102) of the part (302) was above a threshold where the material spreader (120), the hopper (140), the energy emitting device (160), or the printing agent dispenser (180) pulled the part (302) through the build material (150), has ruined that layer of the build, could possibly damage other parts (101) such as parts (305-6, 305-7, 305-8, 305-9), and may damage any of the translatable devices such as the material spreader (120), the hopper (140), the energy emitting device (160), the printing agent dispenser (180), or combinations thereof.

In an example, a number of sequential or non-sequential images of layers in a build may be captured and compared to one another including images of the build regions (151) depicted in FIGS. 3 through 6. FIG. 7 is a block diagram of an image of a build region including grazing light components (701), according to an example of the principles described herein. In one example, the detection of a protrusion (102) by the image analysis module (115) may be performed by analyzing the luminance information within the data representing a first image with the luminance information within the data representing a subsequent image. This analysis may be performed between each image and its subsequent image in order to determine whether a protrusion (102) has formed on any of the parts (301, 302, 303, 304-1, 304-2, 305-1, 305-2, 305-3, 305-4, 305-5, 305-6, 305-7, 305-8, 305-9).

In an example, the various images of the layers of the build described herein as being captured by the image capture device (152) may be captured using different lighting of the build region (151). For example, the illumination devices (154), other ambient light sources, and combinations thereof may play a role in illuminating the build region (151). In one example, the illumination devices (154) included within the additive manufacturing device (200) may be individually activated to allow the image capture device (152) to capture images of the build region (151) under a number of lighting conditions including intensities and wavelengths. In one example, a plurality of the illumination devices (154) may be simultaneously activated to provide a higher intensity of light and/or a wider range of wavelengths of light. Further, an image of the build region (151) may be captured by the image capture device (152) with each of a plurality of illumination devices (154) activated in turn so that each image captured by the image capture device (152) is captured under different lighting conditions.

In one example, the image capture device (152) may be used to capture a first image of a layer of the part (101) with the grazing light (125) not activated and at least one ambient light source activated to obtain a grazing-light-off-image. The image capture device (152) may be used to capture a second image of the same layer of the part (101) with the grazing light (125) activated to obtain a grazing-light-on image. The image analysis module (115) may then remove background portions of the first image and the second image by subtracting the first image from the second image to produce a grazing component (FIG. 7, 701) of the second image. The image analysis module (115) may then identify the illuminated portions (401, 501) and shadow portions (402, 502) of the grazing component (FIG. 7, 701) to identify whether a protrusion (102) exists at that layer of the part (101). In this example, the image as captured in FIG. 3 may be subtracted from the image as captured in either FIG. 4 or FIG. 5 to obtain the grazing component (701) as depicted in FIG. 7. Once the grazing component (701) has been isolated, the grazing component's (701) illuminated portions (401, 501) and shadow portions (402, 502) may be measured for their level of illuminance as to the illuminated portion (401, 501), the width of the shadow portion (402, 502) past the part (302), and combinations thereof to obtain a value of how far above the x,y plane of the last-deposited layer of build material the height of the protrusion (102) extends.

In another example, the image capture device (152) may be used to capture an image of a layer of the part (101) with the grazing light (125) activated and a second light source such as the illumination device (154), activated where the second light source produces a band of wavelengths of light different with respect to the band of wavelengths of light produced by the grazing light (125). The image analysis module (115) may separate the image into a plurality of constituent color planes to obtain the grazing component (701) of the image. Again, once the grazing component (701) has been isolated, the grazing component's (701) illuminated portions (401, 501) and shadow portions (402, 502) may be measured for their level of illuminance as to the illuminated portion (401, 501), the width of the shadow portion (402, 502) past the part (302), and combinations thereof to obtain a value of how far above the x,y plane of the last-deposited layer of build material the height of the protrusion (102) extends.

For example, the images captured by the image capture device (152) may include variations due to nominal lighting, the color of the parts and their appearance within the images as well as details of the surface textures as obtained through illumination by the grazing light (125). The images captured by the image capture device (152) may be segmented into a surface detail component and an image content component. This may be accomplished by capturing a first image of a layer of the part (101) with the grazing light (125) not activated and at least one ambient light source such as the illumination device (154) activated to obtain the grazing-light-off image, and capture a second image of the layer of the part with the grazing light (125) activated to obtain a grazing-light-on image. In this example, the grazing light (125) may include a plurality of separate grazing lights (125) that each output different colors (i.e. wavelengths) of electromagnetic waves. Similarly, the illumination device (154) may include a plurality of separate illumination device (154) that each output different colors (i.e. wavelengths) of electromagnetic waves. By using differently-colored grazing lights (125) and illumination devices (154), the image analysis module (115) may separate the images into constituent color planes. For example, a red-colored grazing light (125) and a green illumination device (154) may assist in obtaining a surface texture image in the red channel. The green-emitting illumination device (154) does not contribute to the red channel, but ambient light from, for example, the energy emitting device (160) or ambient device will contribute to the red channel. By using narrow-band light sources (125, 154) and filters to pass desired grazing light (125) illumination wavelengths, more detail of the part (101) and its potential protruding portions (102) may be more effectively detected. The spatial frequency content of the surface texture obtained in this manner is high, but light from the ambient sources and the energy emitting device (160) intensity variation varies slowly over the image and has low spatial frequency. Further, the color of the build material (150) used to print the part (101) may be considered when selecting output wavelengths of the grazing light (125) and the illumination devices (154). For metal build materials (151) as well, the build material (151) may be colored. Therefore, the output wavelengths of the grazing light (125) and the illumination devices (154) may be selected and tuned to obtain a clear color plane within the images. Thus, detecting the protrusions (102) of the part (101) along the x,y plane may be based on variations of luminance information within data representing the image and may include, with the image capture device (152), capturing an image of a layer of the part (101) with the grazing light (125) activated. The grazing light (125) produces a narrow band illumination. The image analysis module (115) may filter the image to pass the wavelength of the grazing light (125) to obtain a grazing component (FIG. 7, 701) of the image.

In another example, the image capture device (152) may be used to capture a first image of a layer of the part (101) with the grazing light (125) not activated and at least one ambient light source such as the illumination device (154) activated to obtain the grazing-light-off image, and capture a second image of the layer of the part with the grazing light (125) activated to obtain a grazing-light-on image. The image capture device (152) may be used to capture a third image including a calibrating image captured at a beginning of a printing process. The calibrating image may include, for example, the image captured in FIG. 3. The image analysis module (115) may normalize the first image and the second image based on luminance information within data representing the third image. The background portions of the first image and the second image may be obtained by subtracting the first image from the second image to produce a grazing component (701) of the second image. Again, once the grazing component (701) has been isolated, the grazing component's (701) illuminated portions (401, 501) and shadow portions (402, 502) may be measured for their level of illuminance as to the illuminated portion (401, 501), the width of the shadow portion (402, 502) past the part (302), and combinations thereof to obtain a value of how far above the x,y plane of the last-deposited layer of build material the height of the protrusion (102) extends.

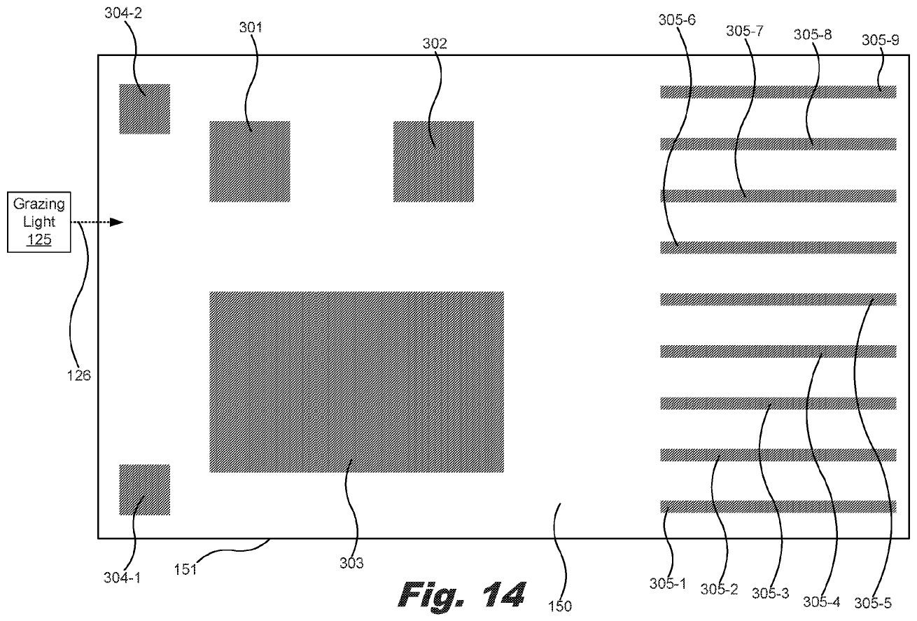

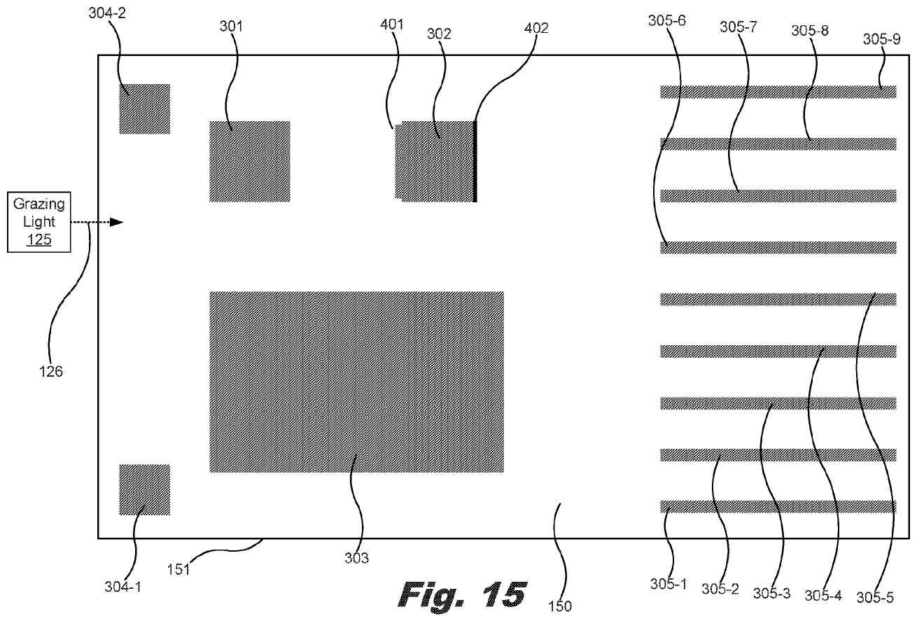

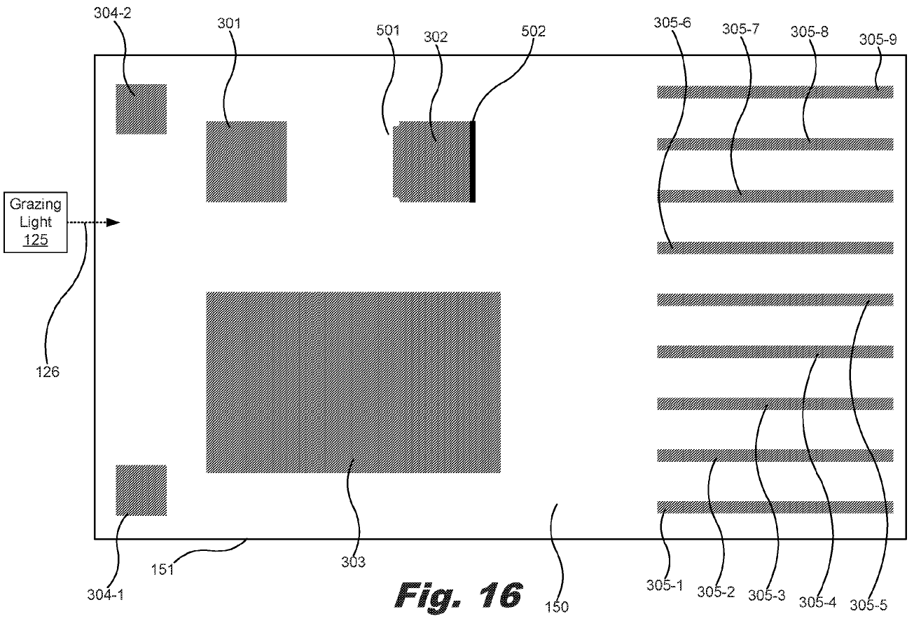

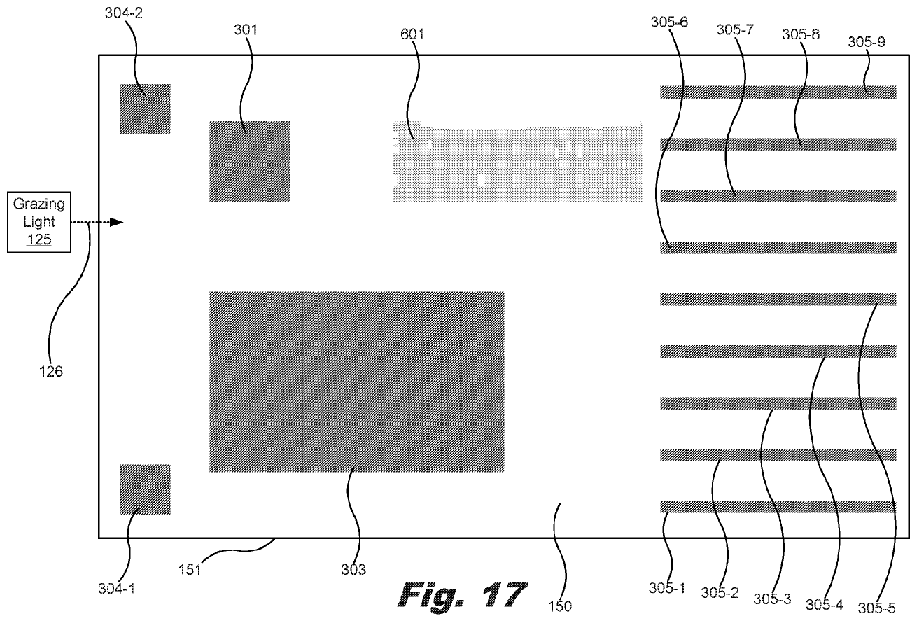

As to the normalization of the first image and the second image, because a plurality of illumination devices (154) may have different color temperatures and different light intensities, an image captured in this scenario may not include a shadow produced from the grazing light (125) impinging on the protrusion (102). FIG. 14 is a block diagram of an image of a build region (151) including a number of parts (101) being printed according to FIG. 3 as normalized, according to an example of the principles described herein. FIG. 15 is a block diagram of an image of a build region (151) including a number of parts (101) being printed and with a grazing light (125) illuminating a protruding portion (102) of one of the parts (302) according to FIG. 4 as normalized, according to an example of the principles described herein. FIG. 16 is a block diagram of an image of a build region (151) including a number of parts (101) being printed and with a grazing light (125) illuminating a stronger protruding portion (102) of one of the parts (302) compared to FIG. 4 according to FIG. 5 as normalized, according to an example of the principles described herein. FIG. 17 is a block diagram of an image of a build region (151) including a number of parts (101) being printed and with one of the parts (302) being subjected to a drag instance (601) according to FIG. 6 as normalized, according to an example of the principles described herein.

Normalization may make the process of shadow detection from the grazing light (125) impinging on the protrusion (102) challenging. Thus, in one example, in order to normalize the images, a calibration patch such as a perfect reflecting diffuser may be used, or declaring the white build powder (150) itself to be white may be used to normalize the first and second images. In this example, the image capture device (152) may capture an image of the build region (151) at the beginning of the printing process with each of a plurality of illumination devices (154) activated in turn to obtain, for example, RGB values such as R₁/G₁/B₁ and R₂/G₂/B₂ for two different illuminations by two different illumination devices (154). In order to normalize the first and second images, the first and second images are assigned a value of 255/255/255, a perfect luminance of 100, or combinations thereof based on the normalization of the R₁/G₁/B₁ and R₂/G₂/B₂. Thus, even in examples where one illumination device (154) was dimmer (lower in illuminance) than the other, the image analysis module (115) will output an RGB value of 255/255/255 in both cases for white. Upon obtaining the normalized first and second images, and the grazing component (701) has been isolated, the grazing component's (701) illuminated portions (401, 501) and shadow portions (402, 502) will be more pronounced. This is demonstrated in FIGS. 14 through 17 as the build material (150) is depicted as white and the parts are depicted as a shade of grey. As depicted in FIGS. 15 and 16, the illuminated portions (401, 501) and shadow portions (402, 502) are more distinguishable as compared to their counterpart images of FIGS. 4 and 5. Similarly, in FIG. 14 the build material (150) is depicted as white and the parts are depicted as a shade of grey, and in FIG. 17, the drag instance (601) is depicted in a lighter grey and white based on the portions of the drag instance (601) protruding high enough to be impinged by the grazing light (125).

As in other examples, the illuminated portions (401, 501) and shadow portions (402, 502) may be measured for their level of illuminance as to the illuminated portion (401, 501), the width of the shadow portion (402, 502) past the part (302), and combinations thereof to obtain a value of how far above the x,y plane of the last-deposited layer of build material the height of the protrusion (102) extends. Normalization in this manner is inspired by color processing in a camera pipeline. In a camera pipeline an illumination estimation may be performed along with a white balancing process. In a camera, the actual illumination is not completely removed. Normalization in the examples described herein assists in obtaining a clear signal. In some examples where normalization is not employed, it may not be obvious within the difference images where the shadows are because the differences may be identified when the illumination devices (154) include different color temperatures and/or different luminance levels. The normalization factors used in this example may include on normalization factor per image. In another example, the normalization factor may apply to an area of the image(s). A perfectly-reflecting diffuser may cover the build region (151), and, in that case, the normalization may take care of non-uniformity of the illumination. The illumination may be more intensive in certain areas than in others. The perfectly-reflecting diffuser may look brighter in some areas than the others.

In another example, the image capture device (152) may be used to capture an image of the build region (151), and the controller (250) may execute the image analysis module (115). The image analysis module (115) may set a number of thresholds of illumination intensity and identify areas within the image where the illumination is above and below the thresholds. In this manner, the image analysis module (115) is able to identify illuminated faces of the protruding portions (102) of the parts (101) and shadow areas caused by the protruding portions (102) within a single image. For example, the illuminated portions (401, 501) and the shadow portions (402, 502) in FIGS. 4 and 5 may be identified by the image analysis module (115). In an example, the image analysis module (115) may observe violations of an upper control limit (UCL) and a lower control limit (LCL) of the illuminated portions (401, 501) and the shadow portions (402, 502). The UCL and the LCL may be thresholds set by the image analysis module (115) to determine when the protrusion (102) exceeds a height that may cause a part drag instance (601) as depicted in FIG. 6.

In one example, the build region (151) may include a perimeter of non-formed (e.g., non-fused or non-sintered) build material (150) that has been deposited and by the hopper (140) and spread by the material spreader (120). This perimeter build material may be layered at an elevation higher than the remainder of the build material (151) and the elevation of the perimeter build material may be known. The perimeter build material may be imaged with the parts (101), and the height of the image analysis module (115) may compare the height of the perimeter build material to the height of any parts (101) including potential protrusions (102).

Again, FIG. 13 is a block diagram of an image of a build region (151) including a number of parts (301, 302, 303, 304-1, 304-2, 305-1, 305-2, 305-3, 305-4, 305-5, 305-6, 305-7, 305-8, 305-9, collectively referred to herein as 101) being printed and a plurality of grazing lights (125-1, 125-2, 125-3, 125-n), according to an example of the principles described herein. The plurality of grazing lights (125-1, 125-2, 125-3, 125-n) provide illumination with orthogonal primary vectors illuminating the build region (151) from, for example, the orthogonal angles around part (302). Although four grazing lights (125) are depicted in FIG. 13, any number of grazing lights (125) may be included, and “n” in “125-n” indicates these potential numbers.

In one example, each of the plurality of grazing lights (125) may provide independent feature measurements from multiple directions with respect to the target parts such as part (302). The acquisition of the multiple independent images may be accomplished by the image capture device (152) capturing a plurality of images of the build region (151) with each captured image including the build region (151) being illuminated by illuminated by a different light source (125-1, 125-2, 125-3, 125-n, 154) or combinations of light sources (125-1, 125-2, 125-3, 125-n, 154). For example, a first image captured by the image capture device (152) may include an image of the build region (151) with the illumination device (154) and none of the grazing lights (125-1, 125-2, 125-3, 125-n) activated. A second image captured by the image capture device (152) may include an image of the build region (151) with the first grazing light (125-1) activated. A third image captured by the image capture device (152) may include an image of the build region (151) with the second grazing light (125-1) activated. A fourth image captured by the image capture device (152) may include an image of the build region (151) with the third grazing light (125-1) activated. This may be performed for each light source (125-1, 125-2, 125-3, 125-n, 154) being activated in turn without other light sources (125-1, 125-2, 125-3, 125-n, 154) being activated. Further, in one example, a combination of the light sources (125-1, 125-2, 125-3, 125-n, 154) may be activated simultaneously as the image capture device (152) captures the images. Still further, the above examples may include activation of the illumination device (154) at different wavelengths and/or intensities of light. Further, each of the grazing lights (125-1, 125-2, 125-3, 125-n) may provide different illumination wavelengths. Provision of different light sources (125-1, 125-2, 125-3, 125-n, 154) outputting different wavelengths of light allows for the image analysis module (115) to extract multiple analysis images from the captured images and separate color channels such as, for example, red, green, and blue channels form RGB images or any number of other spectra.

Further, the image analysis module (115) may combine the lift severity metrics obtained each of the grazing lightings (125-1, 125-2, 125-3, 125-n) and their respective orthogonal directions to increase the confidence and accuracy of the estimated lift in the z-direction that indicates the height amplitude of the lifted part (302). Still further, the image analysis module (115) may combine the x,y position of the lifted portion (102) (depicted as illuminated faces (401, 501) of the part (302)) and shadows (402, 502) from each grazing light direction and use ray tracing analysis to improve the estimated x,y location and shape of the lifted portion (102).

Throughout the description, the purpose of the illumination device (154) is to provide a reference image that includes the printed color information. Further, the illumination device (154) minimizes any shadows or bright faces in the images from surface features by providing overhead lighting over a broad range of angles.

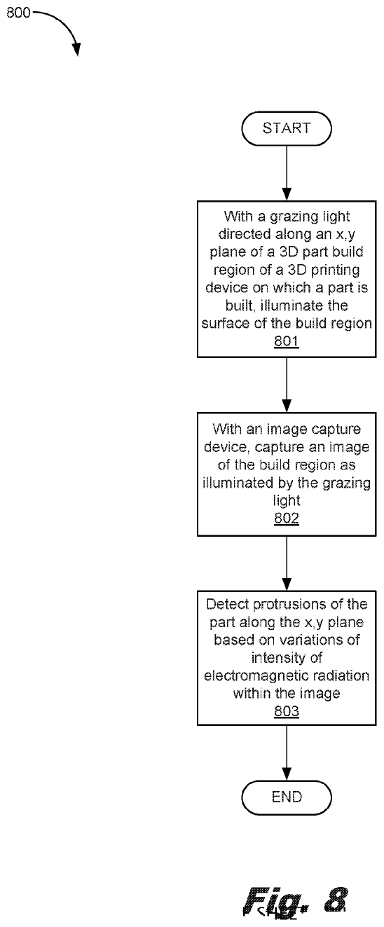

Having described the elements of the additive manufacturing device (100, 200), the methods associated with the additive manufacturing device (100, 200) will now be described. FIG. 8 is a flowchart showing a method (800) of detecting three-dimensional (3D) part (101) lift and drag, according to an example of the principles described herein. The method (800) may include, with a grazing light (125) directed along an x,y plane of a 3D part build region (151) of a 3D printing device on which a part (101) is built, illuminating (block 801) the surface of the build region (151). An image of the build region (151) may be captured (block 802) using an image capture device (152) as illuminated by the grazing light (125). The method (800) may also include detecting (block 803) protrusions (102) of the part (101) along the x,y plane based on variations of luminance information within data representing the image.

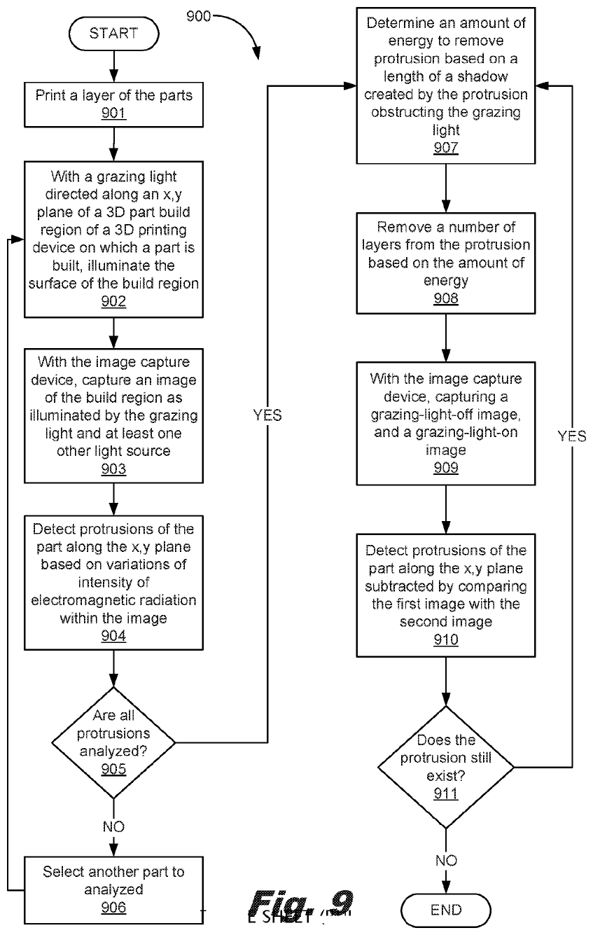

FIG. 9 is a flowchart showing a method (900) of detecting three-dimensional (3D) part lift and drag using at least two light sources, according to an example of the principles described herein. The method (900) may include printing (block 901) a layer of the part(s) (101) included in the build. With a grazing light (125) directed along an x,y plane of a 3D part build region (151) of a 3D printing device on which a part (101) is built, the method (900) may include illuminating (block 902) the surface of the build region (151). An image of the build region (151) may be captured (block 903) using an image capture device (152) as illuminated by the grazing light (125).

The method (900) may also include detecting (block 904) protrusions (102) of the part (101) along the x,y plane based on variations of luminance information within data representing the image. It may then be determined (block 905) whether all possible protrusions (102) that may exist in the build have been analyzed by the image analysis module (115) as executed by the controller (250). In response to a determination that not all possible protrusions (102) that may exist in the build have been analyzed (block 905, determination NO), then the method (900) may include selecting another part (101) to analyze, and the method (900) may loop back to block (902) to do so.

In response to a determination that all possible protrusions (102) that may exist in the build have been analyzed (block 905, determination YES), then the method (900) may include determining (block 907) an amount of energy to remove a protrusion (102) based on a length of a shadow created by the protrusion (102) obstructing the grazing light (125). In one example, the amount of energy to remove a protrusion (102) based on the length of a shadow created by the protrusion (102) obstructing the grazing light (125) as detected by the image analysis module (115), a level of illumination of the protrusion (102) by the grazing light (125) as detected by the image analysis module (115), and combinations thereof.

The method (900) may also include removing (block 908) a number of layers of the protrusion (102) based on the amount of energy determined at block 907. In one example, the removal of the number of layers of the protrusion (102) may be performed by activation of the ablation laser (127). In this example, the energy output by the ablation laser (127) is that energy determined at block 907.

The method (900) may also include, with the image capture device (152), capturing (block 909) a first image of the build region (151) where the build region (151) is not illuminated with the grazing light (125) and/or is illuminated by at least one ambient light source or illumination device (154) activated to obtain a grazing-light-off image, and capturing a second image of the build region (151) where the build region (151) is illuminated by the grazing light (125) and/or is illuminated by at least one ambient light source or illumination device (154) activated to obtain a grazing-light-on image. The image analysis module (115) may compare the plurality of images to one another in order to detect (block 910) the protrusion (102) of the part (101). In order to isolate and obtain a grazing light component (FIG. 7, 701) of the images captured by the image capture device (152), the image analysis module (115) may subtract the first image (i.e., the grazing-light-off image) from the second image (i.e., the grazing-light-on image). This method of isolating the grazing light component (FIG. 7, 701) of the images captured by the image capture device (152) may be performed over a plurality of images that are captured at different times during the building of the part and synchronously aligned pixel by pixel. In one example, an image of each layer may be captured after that layer has been laid down and fused. Once the grazing light component (FIG. 7, 701) of the images is isolated using the image analysis module (115), the image analysis module (115) may identify the variations in luminance within the subtracted images that indicate the presence of lifted portions (102) of the part (101) that protrude past the surface of the build material. The protrusion (102) depicted in FIG. 1 is an exaggeration of proportionality of the protrusion (102), but is shown at this proportionality to properly depict the manner in which the grazing light (125) is able to illuminate the protrusion (102).

These subsequent images are captured at blocks 909 and 910 in order to confirm that the protrusion(s) (102) have been sufficiently removed. Thus, at block 911, it is determined whether the protrusion(s) still exist. In response to the determination that the protrusion(s) (102) still exists (block 911, determination YES), the method (900) may loop back to block 907. However, in response to the determination that the protrusion(s) (102) does not still exist (block 911, determination NO), the method (900) may terminate.

In one example, the images captured at blocks 903 and 909 may be sufficient to detect protrusions (102) that may exist at more than one part (101). Thus, in this example, an image for each part (101) may not be taken to detect protrusion for each part (101). Further, as described herein, more than one of the grazing lights (FIG. 13, 125-1, 125-2, 125-3, 125-n) may be employed to obtain the difference images described in connection with blocks 909 and 910. Thus, in one example, the method may loop back to block 902 for each grazing light (FIG. 13, 125-1, 125-2, 125-3, 125-n) or combinations thereof.

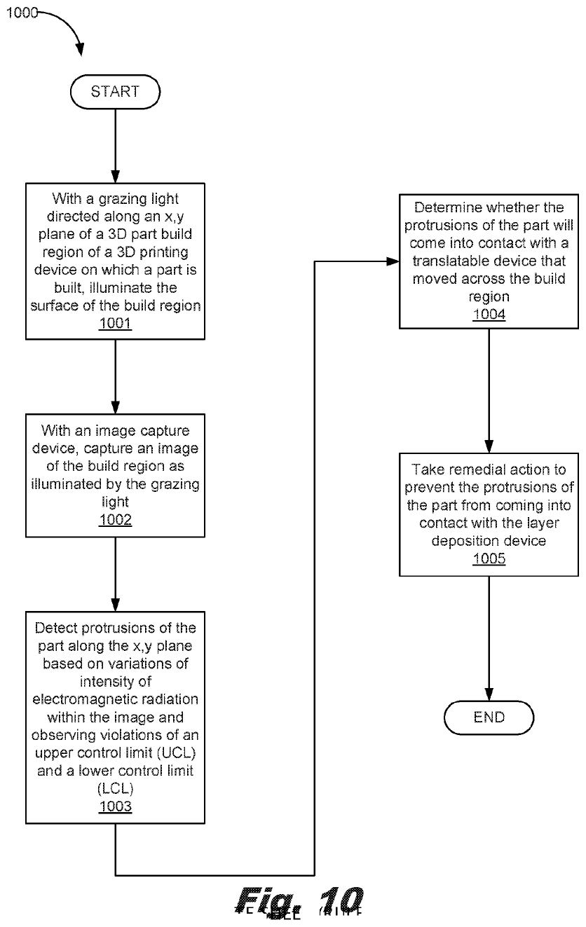

FIG. 10 is a flowchart showing a method (1000) of detecting three-dimensional (3D) part (101) lift and drag, according to an example of the principles described herein. The method (1000) may include, with the grazing light (125) directed along an x,y plane of a 3D part build region (151) of a 3D printing device (100, 200) on which a part (101) is built, illuminating (block 1001) the surface of the build region (151). An image capture device (152) may be used to capture (block 1002) and image of the build region (151) as illuminated by the grazing light (125).

The method (1000) may also include detecting (block 1003) protrusions of the part along the x,y plane based on variations of intensity of electromagnetic radiation within the image and observing violations of an upper control limit (UCL) and a lower control limit (LCL). The method (1000) may also include determining (block 1004) whether the protrusions (102) of the part (101) will come into contact with a translatable device such as the material spreader (120), the hoppers (140), the energy emitting device (160), the printing agent dispenser (180), or combinations thereof that move across the build region (151). This determination may be based on the UCL and LCL or other thresholds.

Remedial actions may be taken (block 1005) to prevent the protrusions (102) of the part (101) from coming into contact with the layer deposition device (120, 140, 160, 180). The remedial action may include adjusting a layer thickness of a subsequent layer of build material that is deposited on a previous layer, adjusting an amount of a printing agent deposited on the build region (151), adjusting torque output by a material spreader (120), removing protrusions (120) from the along the x,y plane with an ablation laser, and combinations thereof.

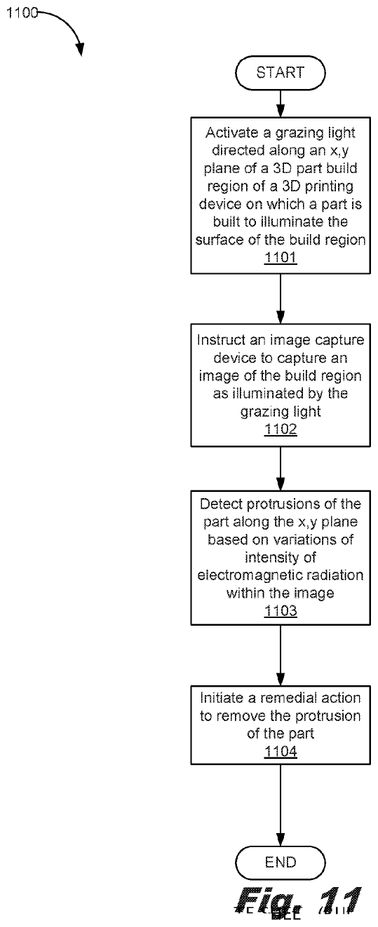

FIG. 11 is a flowchart showing a method (1100) of detecting 3D part (101) lift and drag, according to an example of the principles described herein. The method (1100) may include activating (block 1101) a grazing light (125) directed along an x,y plane of a 3D part build region (151) of a 3D printing device (100, 200) on which a part (101) is built to illuminate the surface of the build region (151). An image capture device (152) may be instructed (block 1102) to capture an image of the build region (151) as illuminated by the grazing light (125). A number of protrusions (102) of the part (101) may be detected (block 1103) along the x,y plane by executing the image analysis module (115) based on variations of intensity of electromagnetic radiation within the image. The method (1100) may also include initiating (block 1104) a remedial action to remove the protrusion (102) of the part (101).

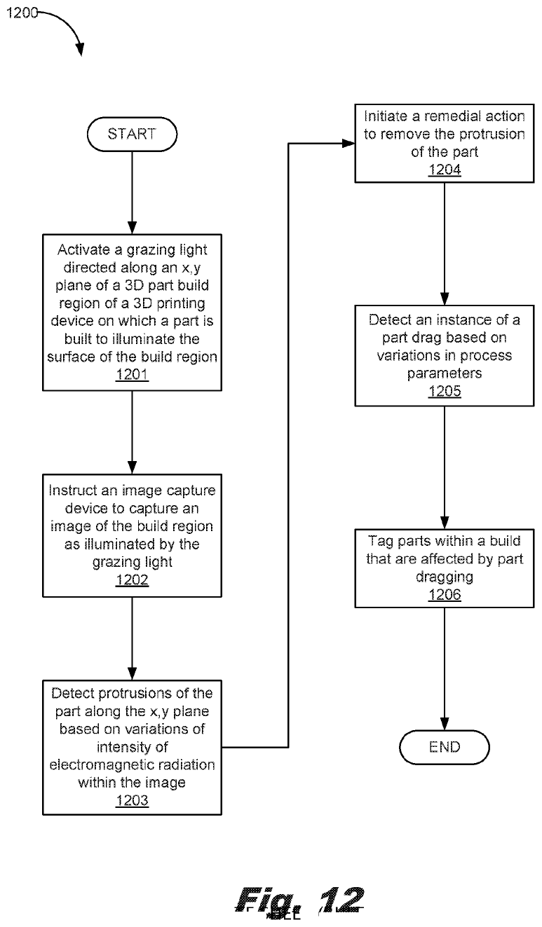

FIG. 12 is a flowchart showing a method (1200) of detecting 3D part (101) lift and drag, according to an example of the principles described herein. The method (1200) may include activating (block 1201) a grazing light (125) directed along an x,y plane of a 3D part build region of a 3D printing device (100, 200) on which a part (101) is built to illuminate the surface of the build region (151). An image capture device (152) may be instructed (block 1202) to capture an image of the build region (151) as illuminated by the grazing light (125). A number of protrusions (102) of the part (101) may be detected (block 1203) along the x,y plane by executing the image analysis module (115) based on variations of intensity of electromagnetic radiation within the image. The method (1200) may also include initiating (block 1204) a remedial action to remove the protrusion (102) of the part (101).

The method (1200) may also include detecting (block 1205) an instance of a part (101) drag based on variations in process parameters. The variations in process parameters may include the UCL and the LCL that may be thresholds set by the image analysis module (115) to determine when the protrusion (102) exceeds a height that may cause a part drag instance (601) as depicted in FIG. 6. The method (1200) may also include tagging (block 1206) or otherwise identify parts (101) within a build that are affected by part dragging (FIG. 6, 601). The tagging (block 1206) of the parts (101) that were affected by part dragging may assist in identifying parts (101) that may not be able to be printed or that may be difficult to print given their history, and may assist in reforming the part and/or changing process parameters in the additive manufacturing device (100, 200). Thus, the tagging (block 1206) of the parts (101) may allow the additive manufacturing device (100, 200) to abandon the printing of a current layer of the part (101) or abandon the part altogether. In one example, blocks 1205 and 1206 are executed in situations where the part lift is not resolved using the other blocks within FIG. 12.

In the examples described herein, in instances where the part is dragged as in FIG. 6, the additive manufacturing device (100, 200) may determine whether the translating devices such as the material spreader (120), the hoppers (140), the energy emitting device (160), the printing agent dispenser (180), and combinations thereof are functioning as intended. For example, the printing agent dispenser (180) may have been damaged in a part (101) dragging instance (FIG. 6, 601) such as nozzles of the printing agent dispenser (180) becoming clogged. The additive manufacturing device (100, 200) may determine whether the translating devices (120, 140, 160, 180) should be repaired or replaced.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the controller (250) of the additive manufacturing device (100, 200) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a grazing light system for detecting three-dimensional (3D) part lift and drag and associated methods may include a grazing light directed along an x,y plane of a build region to illuminate the surface of the build region, an image capture device to capture an image of the build region as illuminated by the grazing light, and an image analysis module to detect protrusions of the part along the x,y plane based on variations of luminance information within data representing the image.

The preceding description has been presented to illustrate and describe examples of the principles described. This description is not intended to be exhaustive or to limit these principles to any precise form disclosed. Many modifications and variations are possible in light of the above teaching.

What is claimed is:

1. A grazing light system for detecting three-dimensional (3D) part lift and drag, comprising:
at least one grazing light directed along an x,y plane of a build region to illuminate the surface of the build region;
an image capture device to capture an image of the build region as illuminated by the grazing light; and
an image analysis module to detect protrusions of the part along the x,y plane based on variations of luminance information within data representing the image.

2. The grazing light system of claim 1, wherein the grazing light is a light emitting diode (LED), a profilometer, a collimated light source, a non-collimated light source, a laser device, a laser diode (LD), or combinations thereof.

3. The grazing light system of claim 1, wherein the image capture device captures images in a visible electromagnetic spectrum, an infrared electromagnetic spectrum, an ultraviolet electromagnetic spectrum, or combinations thereof.

4. The grazing light system of claim 1, comprising an ablation laser to remove the protrusions from along the x,y plane in response to a detection of the protrusion by the image analysis module.

5. The grazing light system of claim 1, wherein detecting protrusions of the part along the x,y plane based on variations of luminance information within data representing the image comprises:
with the image capture device, capturing a first image of a layer of the part with the grazing light not activated and at least one ambient light source activated to obtain a grazing light off image;
with the image capture device, capturing a second image of the layer of the part with the grazing light activated to obtain a grazing light on image; and
removing background portions of the grazing light off image and the grazing light on image by subtracting the grazing light off image from the grazing light on image to produce a grazing component of the second image.

6. The grazing light system of claim 1, wherein detecting protrusions of the part along the x,y plane based on variations of luminance information within data representing the image comprises, with the image capture device:
capturing an image of a layer of the part with the grazing light activated and a second light source activated, the second light source producing a band of wavelengths of light different with respect to the band of wavelengths of light produced by the grazing light; and
separating the image into a plurality of constituent color planes to obtain a grazing component of the image.

7. The grazing light system of claim 1, wherein detecting protrusions of the part along the x,y plane based on variations of luminance information within data representing the image comprises:
with the image capture device, capturing a first image of a layer of the part with the grazing light not activated and at least one ambient light source activated to obtain a grazing light off image;
with the image capture device, capturing a second image of the layer of the part with the grazing light activated to obtain a grazing light on image;
with the image capture device, capturing a third image comprising a calibrating image captured at a beginning of a printing process;
with the image analysis module, normalizing the first image and the second image based on luminance information within data representing the third image; and
removing background portions of the first image and the second image by subtracting the first image from the second image to produce a grazing component of the second image.

8. A method of detecting three-dimensional (3D) part lift and drag, comprising:
with a plurality of grazing lights directed along an x,y plane of a 3D part build region of a 3D printing device on which a part is built, illuminating the surface of the build region;
with an image capture device, capturing an image of the build region as illuminated by the grazing light; and
detecting protrusions of the part along the x,y plane based on variations of luminance information within data representing the image.

9. The method of claim 8, comprising, with an ablation laser, removing protrusions from the along the x,y plane in response to a detection of the protrusions by the image analysis module.

10. The method of claim 8, wherein detecting protrusions of the part along the x,y plane based on variations of intensity of electromagnetic radiation within the image comprises comparing a plurality of captured images to detect the protrusions, subtracting the plurality of captured images from one another to detect the protrusions based in a remaining grazing component, comparing the plurality of images captured at a plurality of wavelengths and separating the image into a plurality of constituent color planes to obtain the grazing component of the image, filtering the image to pass wavelengths of light of the grazing lights to obtain the grazing component of the image, or combinations thereof.

11. The method of claim 8, comprising:
determining whether the protrusions of the part will come into contact with a translatable device that moves across the build region; and
taking remedial action to prevent the protrusions of the part from coming into contact with the layer deposition device.

12. The method of claim 11, wherein the remedial action comprises adjusting a layer thickness of a deposited layer, adjusting an amount of an agent deposited on the build region, adjusting torque output by a material spreader, removing protrusions from the along the x,y plane with an ablation laser, and combinations thereof.

13. The method of claim 8, wherein detecting the protrusions of the part comprises observing violations of an upper control limit (UCL) and a lower control limit (LCL).

14. A non-transitory computer readable medium comprising computer usable program code embodied therewith, the computer usable program code to, when executed by a processor:
activate at least one grazing light directed along an x,y plane of a 3D part build region of a 3D printing device on which a part is built to illuminate the surface of the build region;
instruct an image capture device to capture an image of the build region as illuminated by the grazing light;
detect protrusions of the part along the x,y plane based on variations of intensity of electromagnetic radiation within the image; and
initiate a remedial action to remove the protrusion of the part.

15. The computer readable medium of claim 14, comprising computer usable program code to, when executed by a processor:
detect an instance of a part drag based on variations in process parameters; and
tag parts within a build that are affected by part dragging.
